(19) United States
(12) Patent Application Publication
(10) Pub. No.: US 2024/0117222 A1
(43) Pub. Date: Apr. 11, 2024

(54) ADHESIVE AGENT, ADHESIVE SHEET, OPTICAL FILM PROVIDED WITH ADHESIVE AGENT, AND OPTICAL LAMINATE

(71) Applicant: LINTEC CORPORATION, Tokyo (JP)

(72) Inventors: Sho KOSABA, Tokyo (JP); Takayuki ARAI, Tokyo (JP); Mikihiro KASHIO, Tokyo (JP)

(73) Assignee: LINTEC CORPORATION, Tokyo (JP)

(21) Appl. No.: 18/276,299

(22) PCT Filed: Jan. 27, 2022
(86) PCT No.: PCT/JP2022/002982

§ 371 Date: Aug. 8, 2023

(30) Foreign Application Priority Data
Feb. 8, 2021 (JP) 2021-018436
Feb. 8, 2021 (JP) 2021-018437
Feb. 8, 2021 (JP) 2021-018438

(51) Int. Cl. C09J 7/38; C09J 105/16

(52) U.S. Cl. CPC C09J 7/38; C09J 105/16; C09J 2301/302; C09J 2301/312

(57) ABSTRACT

A pressure sensitive adhesive used in optical applications. The pressure sensitive adhesive contains a modified cyclodextrin having a degree of modification of more than 2.5 and 3.0 or less. The gel fraction of the pressure sensitive adhesive is 1.0% or more. Such a pressure sensitive adhesive is excellent in the durability even at high temperatures.

### TECHNICAL FIELD

The present invention relates to a pressure sensitive adhesive, a pressure sensitive adhesive sheet, an optical film with pressure sensitive adhesive layer, and an optical laminate and relates particularly to a pressure sensitive adhesive and a pressure sensitive adhesive sheet that are suitable for bonding a polarization plate, a retardation plate, etc. and an optical film with pressure sensitive adhesive layer and an optical laminate that each include a polarization plate, a retardation plate, etc.

### BACKGROUND ART

In recent years, image display devices such as liquid crystal displays are often used as display bodies (displays) of various electronic devices. Most recently, the use of organic electroluminescence (organic EL) displays has been increasing.

Displays such as those described above are produced by laminating various optical members. Examples of optical members include polarization plates, retardation plates, etc., which may be adhered and laminated using a pressure sensitive adhesive.

The above pressure sensitive adhesive may be used in the form of a pressure sensitive adhesive layer of a pressure sensitive adhesive sheet. Examples of pressure sensitive adhesive sheets used for laminating optical members include those disclosed in Patent Document 1. In such examples, the pressure sensitive adhesive layer of a pressure sensitive adhesive sheet is formed of a pressure sensitive adhesive composition that contains a (meth)acrylic ester polymer (A) and cyclodextrins (B). Cited Document 1 also discloses that a modified cyclodextrin having a degree of substitution (degree of modification) of 0.2 to 2.5 can be used as the above cyclodextrins (B).

### PRIOR ART DOCUMENTS

### Patent Documents

[Patent Document 1] WO2015/151224

### SUMMARY OF THE INVENTION

### Problems to be Solved by the Invention

Displays such as those described above may be used in situations in which they are exposed to high temperatures. For example, the temperature of a display installed outdoors increases due to exposure to sunlight for a long period of time. In mobile terminals such as smartphones, the display receives heat from members that generate heat, such as processors and batteries. When the display is exposed to high temperatures as described above, the conventional pressure sensitive adhesive may cause a problem in that floating or delamination of the bonded members occurs.

The present invention has been made in view of such actual circumstances, and objects of the present invention include providing a pressure sensitive adhesive, a pressure sensitive adhesive sheet, an optical film with pressure sensitive adhesive layer, and an optical laminate that are excellent in the durability even under high temperatures.

### Means for Solving the Problems

To achieve the above objects, first, the present invention provides a pressure sensitive adhesive used in optical applications, the pressure sensitive adhesive containing a modified cyclodextrin having a degree of modification of more than 2.5 and 3.0 or less, the pressure sensitive adhesive having a gel fraction of 1.0% or more (Invention 1).

The pressure sensitive adhesive in the above invention (Invention 1) contains the modified cyclodextrin having the above-described degree of modification, and the gel fraction falls within the above range, so that even when the pressure sensitive adhesive is placed under a high-temperature environment, floating or delamination is less likely to occur between the pressure sensitive adhesive and bonded members and exhibits excellent high-temperature durability.

In the above invention (Invention 1), the modified cyclodextrin may be preferably at least one of a modified β-cyclodextrin and a modified γ-cyclodextrin (Invention 2).

In the above invention (Invention 1, 2), the modified cyclodextrin may be preferably a cyclodextrin modified with an acyl group (Invention 3).

In the above invention (Invention 1 to 3), the pressure sensitive adhesive may preferably contain a crosslinked product obtained by crosslinking a (meth)acrylic ester polymer with a crosslinker (Invention 4)

Second, the present invention provides a pressure sensitive adhesive sheet having a pressure sensitive adhesive layer, the pressure sensitive adhesive layer being composed of the pressure sensitive adhesive (Invention 1 to 4) (Invention 5).

In the above invention (Invention 5), the 1000% modulus when a tensile test is performed at 23° C. may be preferably 0.15 N/mm² or more and 1.00 N/mm² or less (Invention 6).

In the above invention (Invention 5, 6), the adhesive strength to soda-lime glass at 23° C. may be preferably 1 N/25 mm or more and 60 N/25 mm or less (Invention 7).

Third, the present invention provides an optical film with pressure sensitive adhesive layer, comprising: an optical film; and a pressure sensitive adhesive layer laminated on at least one surface of the optical film, the pressure sensitive adhesive layer being that of the pressure sensitive adhesive sheet (Invention 5 to 7) (Invention 8).

Fourth, the present invention provides an optical laminate comprising: a first optical film; a second optical film; and a pressure sensitive adhesive layer that bonds the first optical film and the second optical film to each other, the pressure sensitive adhesive layer being that of the pressure sensitive adhesive sheet (Invention 5 to 7) (Invention 9).

### Advantageous Effect of the Invention

The pressure sensitive adhesive, pressure sensitive adhesive sheet, optical film with pressure sensitive adhesive layer, and optical laminate according to the present invention are excellent in the durability even under high temperatures.

### BRIEF DESCRIPTION OF DRAWINGS

FIG. 1 is a cross-sectional view of a pressure sensitive adhesive sheet according to the first, second, and third embodiments of the present invention.

FIG. 2 is a cross-sectional view of an optical film with pressure sensitive adhesive layer according to the first embodiment of the present invention.

FIG. 3 is a cross-sectional view of an optical laminate according to the first embodiment of the present invention.

FIG. 4 is a cross-sectional view of a repetitive bending laminate member according to the second and third embodiments of the present invention.

FIG. 5 is a cross-sectional view of a repetitive bending device according to the second and third embodiments of the present invention.

FIG. 6 is an explanatory diagram (side view) for describing the bending test.

### EMBODIMENTS FOR CARRYING OUT THE INVENTION

### First Embodiment

The first embodiment of the present invention will be described below.

### <Pressure Sensitive Adhesive>

The pressure sensitive adhesive according to an embodiment of the present invention is that used in optical applications. The pressure sensitive adhesive contains a modified cyclodextrin having a degree of modification of more than 2.5 and 3.0 or less. The gel fraction of the pressure sensitive adhesive is 1.0% or more.

The pressure sensitive adhesive according to the present embodiment contains the modified cyclodextrin having the above-described degree of modification and can thereby have good plasticity. This allows the pressure sensitive adhesive according to the present embodiment to well follow the deformation of a member to which the pressure sensitive adhesive is bonded, even when the member is deformed (especially contracted) under a high-temperature environment. Furthermore, the pressure sensitive adhesive according to the present embodiment contains the above-described modified cyclodextrin and has the above-described gel fraction, thereby having a high cohesive strength. As a result, even under a high-temperature environment, the pressure sensitive adhesive according to the present embodiment is less likely to cause floating or delamination from a member to which the pressure sensitive adhesive is bonded, and can exhibit excellent high-temperature durability.

The type of the pressure sensitive adhesive according to the present embodiment is not particularly limited, provided that it contains the above-described modified cyclodextrin and satisfies the above-described gel fraction. For example, the pressure sensitive adhesive according to the present embodiment may be any of an acrylic-based pressure sensitive adhesive, a polyester-based pressure sensitive adhesive, a polyurethane-based pressure sensitive adhesive, a rubber-based pressure sensitive adhesive, a silicone-based pressure sensitive adhesive, etc. The pressure sensitive adhesive according to the present embodiment may be any of emulsion type, solvent type, or non-solvent type and may also be crosslinked type or non-crosslinked type. Among these, acrylic-based pressure sensitive adhesives may be preferred because they are excellent in the pressure sensitive adhesive physical properties, optical properties, etc. As the acrylic-based pressure sensitive adhesives, crosslinking type ones may be preferred, and thermal crosslinking type ones may be further preferred.

The pressure sensitive adhesive according to the present embodiment may be non-curable with active energy rays or curable with active energy rays. When the pressure sensitive adhesive according to the present embodiment is non-curable with active energy rays, the pressure sensitive adhesive may be preferably one obtained by crosslinking a pressure sensitive adhesive composition that contains a (meth)acrylic ester polymer (A), a modified cyclodextrin (B), and a crosslinker (C) and optionally a silane coupling agent (D) (such a pressure sensitive adhesive composition may be referred to as a “pressure sensitive adhesive composition P,” hereinafter). This allows the pressure sensitive adhesive according to the present embodiment to contain a crosslinked product obtained by crosslinking the (meth)acrylic ester polymer with a crosslinker, and the pressure sensitive adhesive can readily satisfy the above-described gel fraction. As used in the present specification, the term “(meth)acrylic acid” refers to both the acrylic acid and the methacrylic acid. The same applies to other similar terms. As used in the present specification, the term “polymer” encompasses the concept of a “copolymer.”

### 1. Components of Pressure Sensitive Adhesive Composition P

### (1) (Meth)Acrylic Ester Polymer (A)

The (meth)acrylic ester polymer (A) in the present embodiment may preferably contain, as a monomer unit that constitutes the polymer, a reactive group-containing monomer having in the molecule a reactive group that reacts with the crosslinker (C). The reactive group derived from the reactive group-containing monomer reacts with the crosslinker (C) to form a crosslinked structure (three-dimensional network structure), and the pressure sensitive adhesive to be obtained can further readily satisfy the aforementioned gel fraction.

Preferred examples of the above reactive group-containing monomer include a monomer having a hydroxyl group in the molecule (hydroxyl group-containing monomer), a monomer having a carboxy group in the molecule (carboxy group-containing monomer), and a monomer having an amino group in the molecule (amino group-containing monomer). Among these, the hydroxyl group-containing monomer or carboxy group-containing monomer may be preferred because it is excellent in the reactivity with the crosslinker (C).

Examples of the hydroxyl group-containing monomer include hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth) acrylate, 3-hydroxybutyl (meth)acrylate, and 4-hydroxybutyl (meth)acrylate. Among these, hydroxyalkyl (meth)acrylates having a hydroxyalkyl group whose carbon number is 1 to 4 may be preferred from the viewpoints of the reactivity of the hydroxyl group in the obtained (meth)acrylic ester polymer (A) with the crosslinker (C) and the copolymerizability with other monomers. Specifically, for example, 2-hydroxyethyl (meth) acrylate, 4-hydroxybutyl (meth)acrylate, or the like may be preferred, and 2-hydroxyethyl acrylate or 4-hydroxybutyl acrylate may be particularly preferred. These may each be used alone or two or more types may also be used in combination.

Examples of the carboxy group-containing monomer include ethylenically unsaturated carboxylic acids such as acrylic acid, methacrylic acid, crotonic acid, maleic acid, itaconic acid, and citraconic acid. Among these, acrylic acid may be preferred from the viewpoints of the reactivity of the carboxy group in the obtained (meth)acrylic ester polymer (A) with the crosslinker (C) and the copolymerizability with other monomers. These may each be used alone or two or more types may also be used in combination.

Examples of the amino group-containing monomer include aminoethyl (meth)acrylate and n-butylaminoethyl (meth)acrylate. These may each be used alone or two or more types may also be used in combination. Nitrogen atom-containing monomers, which will be described later, are excluded from the amino group-containing monomers.

The (meth)acrylic ester polymer (A) may preferably contain, as the lower limit, 0.1 mass % or more, particularly preferably 1 mass % or more, and further preferably 3 mass % or more of the reactive group-containing monomer as a monomer unit that constitutes the polymer. From another aspect, the (meth)acrylic ester polymer (A) may preferably contain, as the upper limit, 20 mass % or less, particularly preferably mass % or less, and further preferably 6 mass % or less of the reactive group-containing monomer as a monomer unit that constitutes the polymer. When the (meth)acrylic ester polymer (A) contains the reactive group-containing monomer in the above amount as a monomer unit, a good crosslinked structure is formed in the obtained pressure sensitive adhesive, and the obtained pressure sensitive adhesive can readily satisfy the aforementioned gel fraction.

The (meth)acrylic ester polymer (A) may preferably contain (meth)acrylic alkyl ester as a monomer unit that constitutes the polymer. This can readily develop good pressure sensitive adhesive properties. The alkyl group in the (meth)acrylic alkyl ester may be linear or branched.

From the viewpoint of the pressure sensitive adhesive properties, (meth)acrylic alkyl ester whose carbon number of alkyl group is 1 to 20 may be preferred as the (meth)acrylic alkyl ester. Examples of the (meth)acrylic alkyl ester whose carbon number of alkyl group is 1 to 20 include methyl (meth)acrylate, ethyl (meth)acrylate, propyl (meth)acrylate, n-butyl (meth)acrylate, n-pentyl (meth)acrylate, n-hexyl (meth) acrylate, 2-ethylhexyl (meth) acrylate, isooctyl (meth)acrylate, n-decyl (meth)acrylate, n-dodecyl (meth)acrylate, myristyl (meth)acrylate, palmityl (meth)acrylate, and stearyl (meth)acrylate. Among these, from the viewpoint of more improving the pressure sensitive adhesive properties, (meth)acrylic ester whose carbon number of alkyl group is 4 to 8 may be preferred, n-butyl (meth)acrylate, 2-ethylhexyl (meth)acrylate, or isooctyl (meth)acrylate may be particularly preferred, and n-butyl acrylate may be further preferred. These may each be used alone or two or more types may also be used in combination.

The (meth)acrylic ester polymer (A) may preferably contain 30 mass % or more, more preferably 50 mass % or more, particularly preferably 70 mass % or more, and further preferably 90 mass % or more of the (meth)acrylic alkyl ester as a monomer unit that constitutes the polymer. When the lower limit of the content of the (meth)acrylic alkyl ester satisfies the above, the (meth)acrylic ester polymer (A) can exhibit good pressure sensitive adhesive properties. On the other hand, the (meth)acrylic ester polymer (A) may preferably contain 99.9 mass % or less, particularly preferably 99 mass % or less, and further preferably 97 mass % or less of the (meth)acrylic alkyl ester. When the upper limit of the content of the (meth)acrylic alkyl ester satisfies the above, a desired amount of other monomers such as a reactive functional group-containing monomer can be readily introduced into the (meth)acrylic ester polymer (A).

If desired, the (meth)acrylic ester polymer (A) may contain other monomers as monomer units that constitute the polymer. Examples of such monomers include a monomer having an alicyclic structure in the molecule (alicyclic structure-containing monomer), a non-reactive nitrogen atom-containing monomer such as N-acryloyl morpholine or N-vinyl-2-pyrrolidone, alkoxyalkyl (meth)acrylates such as methoxyethyl (meth)acrylate and ethoxyethyl (meth)acrylate, vinyl acetate, and styrene. These may each be used alone or two or more types may also be used in combination.

The (meth)acrylic ester polymer (A) may be preferably a linear polymer. Such a linear polymer may promote the entanglement of molecular chains, and improvement in the cohesive force can be expected, so the pressure sensitive adhesive to be obtained can readily achieve more excellent high-temperature durability.

The (meth)acrylic ester polymer (A) may be preferably a solution polymerization product obtained by a solution polymerization method. Being a solution polymerization product allows a high molecular-weight polymer to be easily obtained, and improvement in the cohesive force can be expected, so the pressure sensitive adhesive to be obtained can readily achieve more excellent high-temperature durability.

The polymerization form of the (meth)acrylic ester polymer (A) may be a random copolymer or may also be a block copolymer.

The weight-average molecular weight of the (meth)acrylic ester polymer (A) may be preferably 300,000 or more, more preferably 800,000 or more, and particularly preferably 1,600,000 or more from the viewpoint of making molecules of the (meth)acrylic ester polymer (A) sufficiently entangled with each other so that both the aforementioned gel fraction and the 1000% modulus to be described later can be readily achieved. From the same viewpoint, the weight-average molecular weight of the (meth)acrylic ester polymer (A) may be preferably 3,000,000 or less, particularly preferably 2,500,000 or less, and further preferably 2,200,000 or less. As used in the present specification, the weight-average molecular weight refers to a standard polystyrene equivalent value that is measured by using a gel permeation chromatography (GPC) method.

In the pressure sensitive adhesive composition P, one type of the (meth)acrylic ester polymer (A) may be used alone or two or more types may also be used in combination.

### (2) Modified Cyclodextrin (B)

The modified cyclodextrin (B) in the present embodiment is not particularly limited, provided that the hydroxyl group is substituted by another functional group with a degree of modification of more than 2.5 and 3.0 or less.

In general, cyclodextrins having 5 or more glucose constitutional units are known. The cyclodextrin serving as the skeleton of the modified cyclodextrin (B) in the present embodiment may be cyclodextrin having 5 glucose constitutional units, α-cyclodextrin having 6 glucose constitutional units, β-cyclodextrin having 7 glucose constitutional units, or γ-cyclodextrin having 8 glucose constitutional units. Among them, the modified cyclodextrin (B) in the present embodiment may be at least one of those obtained by modifying β-cyclodextrin (modified β-cyclodextrin) and modifying γ-cyclodextrin (modified γ-cyclodextrin) from the viewpoints of readily imparting better plasticity to the pressure sensitive adhesive and readily achieving higher cohesive strength.

As used in the present specification, “modified” in the modified cyclodextrin (B) means that at least part of the hydroxyl groups of the cyclodextrin are substituted with other functional groups. Here, examples of other functional groups include alkoxy groups such as a methoxy group and an ethoxy group and acyl groups such as an acetyl group. Among these, acyl groups may be preferred and an acetyl group may be particularly preferred from the viewpoint of readily imparting excellent plasticity to the pressure sensitive adhesive.

The degree of modification of the modified cyclodextrin (B) in the present embodiment is more than 2.5 as described above. From the viewpoints of readily imparting better plasticity to the pressure sensitive adhesive and readily achieving higher cohesive strength, the degree of modification may be preferably 2.7 or more and particularly preferably 2.8 or more. The upper limit of the degree of modification of the modified cyclodextrin (B) is not particularly limited, but may be 3.0 or less in an embodiment, 2.99 or less in another embodiment, or 2.98 or less in still another embodiment. As used in the present specification, the degree of modification of the modified cyclodextrin is the number of hydroxyl groups substituted with other functional groups per one glucose constitutional unit. Therefore, if three hydroxyl groups in one glucose constitutional unit are all substituted, the degree of modification is 3.0.

In the pressure sensitive adhesive composition P, one type of the modified cyclodextrin (B) may be used alone or two or more types may also be used in combination.

The content of the modified cyclodextrin (B) in the pressure sensitive adhesive composition P may be preferably 0.1 mass parts or more, more preferably 2 mass parts or more, particularly preferably 7 mass parts or more, and further preferably 13 mass parts or more with respect to 100 mass parts of the (meth)acrylic ester polymer (A). From another aspect, the content of the modified cyclodextrin (B) in the pressure sensitive adhesive composition P may be preferably 50 mass parts or less, particularly preferably 30 mass parts or less, and further preferably 20 mass parts or less with respect to 100 mass parts of the (meth)acrylic ester polymer (A). When the content of the modified cyclodextrin (B) with respect to 100 mass parts of the (meth)acrylic ester polymer (A) is 0.1 mass parts or more, the pressure sensitive adhesive according to the present embodiment can exhibit better plasticity and have a higher cohesive strength. When the above content is 50 mass parts or less, the pressure sensitive adhesive according to the present embodiment can readily exhibit the desired adhesive strength.

### (3) Crosslinker (C)

It suffices that the crosslinker (C) is reactive with a reactive group of the (meth)acrylic ester polymer (A). Examples of the crosslinker (B) include an isocyanate-based crosslinker, an epoxy-based crosslinker, an amine-based crosslinker, a melamine-based crosslinker, an aziridine-based crosslinker, a hydrazine-based crosslinker, an aldehyde-based crosslinker, an oxazoline-based crosslinker, a metal alkoxide-based crosslinker, a metal chelate-based crosslinker, a metal salt-based crosslinker, and an ammonium salt-based crosslinker. Among them, it may be preferred to use at least one of an isocyanate-based crosslinker that is highly reactive with hydroxyl groups and an epoxy-based crosslinker that is highly reactive with carboxyl groups. In particular, when the (meth)acrylic ester polymer (A) contains both a hydroxyl group-containing monomer and a carboxyl group-containing monomer as monomers that constitute the polymer, it may be preferred to use a combination of an isocyanate-based crosslinker and an epoxy-based crosslinker. Thus, one type of the crosslinker (B) may be used alone or two or more types may also be used in combination.

The isocyanate-based crosslinker contains at least a polyisocyanate compound. Examples of the polyisocyanate compound include aromatic polyisocyanates such as tolylene diisocyanate, diphenylmethane diisocyanate, and xylylene diisocyanate, aliphatic polyisocyanates such as hexamethylene diisocyanate, alicyclic polyisocyanates such as isophorone diisocyanate and hydrogenated diphenylmethane diisocyanate, biuret bodies and isocyanurate bodies thereof, and adduct bodies that are reaction products with low molecular active hydrogen-containing compounds such as ethylene glycol, propylene glycol, neopentyl glycol, trimethylol propane, and castor oil. Among these, from the viewpoint of reactivity with hydroxyl groups, trimethylolpropane-modified aromatic polyisocyanate may be preferred, and trimethylolpropane-modified tolylene diisocyanate may be particularly preferred.

Examples of the epoxy-based crosslinkers include 1,3-bis(N,N-diglycidylaminomethyl)cyclohexane, N,N,N′,N′-tetraglycidyl-m-xylylenediamine, ethylene glycol diglycidyl ether, 1,6-hexanediol diglycidyl ether, trimethylolpropane diglycidyl ether, diglycidylaniline, and diglycidylamine. Among these, N,N,N′,N′-tetraglycidyl-m-xylylenediamine may be preferred from the viewpoint of reactivity with carboxy groups.

The content of the crosslinker (C) in the pressure sensitive adhesive composition P may be preferably 0.001 mass parts or more, particularly preferably 0.01 mass parts or more, and further preferably 0.1 mass parts or more with respect to 100 mass parts of the (meth)acrylic ester polymer (A). From another aspect, the content of the crosslinker (C) may be preferably 10 mass parts or less, particularly preferably 1 mass part or less, and further preferably 0.5 mass parts or less with respect to 100 mass parts of the (meth) acrylic ester polymer (A). When the content of the crosslinker (B) falls within the above range, the gel fraction of the pressure sensitive adhesive to be obtained can be readily adjusted within the aforementioned range, and the desired adhesive strength can be readily achieved.

### (4) Silane Coupling Agent (D)

The pressure sensitive adhesive composition P may preferably contain the silane coupling agent (D). This can improve the interfacial adhesion with an adherend even when the adherend is a plastic member or a glass member, and excellent high-temperature durability can be readily achieved.

The silane coupling agent (D) may be preferably an organosilicon compound having at least one alkoxysilyl group in the molecule, which has satisfactory compatibility with the (meth)acrylic ester polymer (A).

Examples of such a silane coupling agent (D) include polymerizable unsaturated group-containing silicon compounds such as vinyltrimethoxysilane, vinyltriethoxysilane and methacryloxypropyltrimethoxysilane, silicon compounds having an epoxy structure, such as 3-glycidoxypropyltrimethoxysilane and 2-(3,4-epoxycyclohexyl)ethyltrimethoxysilane, mercapto group-containing silicon compounds such as 3-mercaptopropyltrimethoxysilane, 3-mercaptopropyltriethoxysilane and 3-mercaptopropyldimethoxymethylsilane, amino group-containing silicon compounds such as 3-aminopropyltrimethoxysilane, N-(2-aminoethyl)-3-aminopropyltrimethoxysilane and N-(2-aminoethyl)-3-aminopropylmethyldimethoxysilane, 3-chloropropyltrimethoxysilane, 3-isocyanatepropyltriethoxysilane, and condensates of at least one of these and an alkyl group-containing silicon compound such as methyltriethoxysilane, ethyltriethoxysilane, methyltrimethoxysilane and ethyltrimethoxysilane. These may each be used alone or two or more types may also be used in combination.

The content of the silane coupling agent in the pressure sensitive adhesive composition P may be preferably 0.01 mass parts or more, particularly preferably 0.05 mass parts or more, and further preferably 0.1 mass parts or more with respect to 100 mass parts of the (meth)acrylic ester polymer (A). From another aspect, the content may be preferably 1.2 mass parts or less, particularly preferably 0.8 mass part or less, and further preferably 0.4 mass parts or less.

### (5) Various Additives

If desired, the pressure sensitive adhesive composition P can contain one or more of various additives, such as an antirust, an ultraviolet absorber, an antistatic, a tackifier, an antioxidant, a light stabilizer, a softening agent, and a refractive index adjuster, which are commonly used in acrylic-based pressure sensitive adhesives. The additives which constitute the pressure sensitive adhesive composition P are deemed not to include a polymerization solvent or a diluent solvent, which will be described later.

### 2. Preparation of Pressure Sensitive Adhesive Composition P

The pressure sensitive adhesive composition P can be prepared through producing the (meth)acrylic ester polymer (A) and mixing the obtained (meth)acrylic ester polymer (A) with the modified cyclodextrin (B) and the crosslinker (C) and optionally adding the silane coupling agent (D), other additives, etc.

The (meth)acrylic ester polymer (A) can be produced by polymerizing a mixture of the monomers which constitute the polymer using a commonly-used radical polymerization method. Polymerization of the (meth)acrylic ester polymer (A) may be preferably carried out by a solution polymerization method, if desired, using a polymerization initiator. However, the present invention is not limited to this, and the polymerization may be performed without a solvent. Examples of the polymerization solvent include ethyl acetate, n-butyl acetate, isobutyl acetate, toluene, acetone, hexane, and methyl ethyl ketone, and two or more types thereof may also be used in combination.

Examples of the polymerization initiator include azo-based compounds and organic peroxides and two or more types thereof may also be used in combination. Examples of the azo-based compounds include 2,2′-azobisisobutyronitrile, 2,2′-azobis(2-methylbutyronitrile), 1,1′-azobis(cyclohexane 1-carbonitrile), 2,2′-azobis(2,4-dimethylvaleronitrile), 2,2′-azobis(2,4-dimethyl-4-methoxyvaleronitrile), dimethyl 2,2′-azobis(2-methylpropionate), 4,4′-azobis(4-cyanovaleric acid), 2,2′-azobis(2-hydroxymethylpropionitrile), and 2,2′-azobis[2-(2-imidazolin-2-yl)propane].

Examples of the organic peroxides include benzoyl peroxide, t-butyl perbenzoate, cumene hydroperoxide, diisopropyl peroxydicarbonate, di-n-propyl peroxydicarbonate, di(2-ethoxyethyl)peroxydicarbonate, t-butyl peroxyneodecanoate, t-butyl peroxybivalate, (3,5,5-trimethylhexanoyl)peroxide, dipropionyl peroxide, and diacetyl peroxide.

In the above polymerization step, the weight-average molecular weight of the polymer to be obtained can be adjusted by compounding a chain transfer agent such as 2-mercaptoethanol.

After the (meth)acrylic ester polymer (A) is obtained, the pressure sensitive adhesive composition P (coating solution) diluted with a solvent may be obtained through adding the modified cyclodextrin (B) and the crosslinker (C) and optionally a diluent solvent, the silane coupling agent (D), other additives, etc. to the solution of the (meth)acrylic ester polymer (A) and sufficiently mixing them. If any of the above components is in the form of a solid, or if precipitation occurs when the component is mixed with another component in an undiluted state, the component may be preliminarily dissolved in or diluted with a diluent solvent alone and then mixed with the other component.

Examples of the above diluent solvent for use include aliphatic hydrocarbons such as hexane, heptane and cyclohexane, aromatic hydrocarbons such as toluene and xylene, halogenated hydrocarbons such as methylene chloride and ethylene chloride, alcohols such as methanol, ethanol, propanol, butanol and 1-methoxy-2-propanol, ketones such as acetone, methyl ethyl ketone, 2-pentanone, isophorone and cyclohexanone, esters such as ethyl acetate and butyl acetate, and cellosolve-based solvents such as ethyl cellosolve.

The concentration/viscosity of the coating solution thus prepared is not particularly limited and can be appropriately selected depending on the situation, provided that the concentration/viscosity is within any range in which the coating is possible. For example, the pressure sensitive adhesive composition P may be diluted to a concentration of 10 to 60 mass %. When obtaining the coating solution, the addition of a diluent solvent or the like is not a necessary condition, and the diluent solvent may not be added if the pressure sensitive adhesive composition P has a viscosity or the like that enables the coating. In this case, the pressure sensitive adhesive composition P may be a coating solution in which the polymerization solvent itself for the (meth) acrylic ester polymer (A) is used as a diluent solvent.

### 3. Production of Pressure Sensitive Adhesive

The pressure sensitive adhesive can be obtained by crosslinking the pressure sensitive adhesive composition P. Crosslinking of the pressure sensitive adhesive composition P can be usually performed by heat treatment. Drying treatment when volatilizing a diluent solvent and the like from the coating film of the pressure sensitive adhesive composition P applied to a desired object can also serve as the above heat treatment.

The heating temperature of the heat treatment may be preferably 50° C. to 150° C. and particularly preferably 70° C. to 120° C. The heating time may be preferably 10 seconds to 10 minutes and particularly preferably 50 seconds to 2 minutes.

After the heat treatment, if necessary, an aging period at an ordinary temperature (e.g., 23° C., 50% RH) for about 1 to 2 weeks may be provided. When the aging period is necessary, the pressure sensitive adhesive is formed after the aging period has elapsed, while when the aging period is not necessary, the pressure sensitive adhesive is formed after the heat treatment has been completed.

The above heat treatment (and aging) allows the (meth)acrylic ester polymer (A) to be crosslinked via the crosslinker (B), and the pressure sensitive adhesive can thus be obtained.

### 4. Gel Fraction of Pressure Sensitive Adhesive

The gel fraction of the pressure sensitive adhesive according to the present embodiment is 1% or more. This allows the pressure sensitive adhesive of the present embodiment to have a high cohesive strength, and in a synergistic manner with containing the aforementioned modified cyclodextrin (B), even under a high-temperature environment, floating or delamination from a member to which the pressure sensitive adhesive is bonded is less likely to occur. From this view point, the above gel fraction may be preferably 10% or more, particularly preferably 30% or more, and further preferably 60% or more. The upper limit of the gel fraction of the pressure sensitive adhesive according to the present embodiment is not particularly limited, and may be, for example, 100% or less in an embodiment, 90% or less in another embodiment, or 80% or less in still another embodiment. Details of the measurement method for the above gel fraction are as described in the Testing Example, which will be described later.

### <Pressure Sensitive Adhesive Sheet>

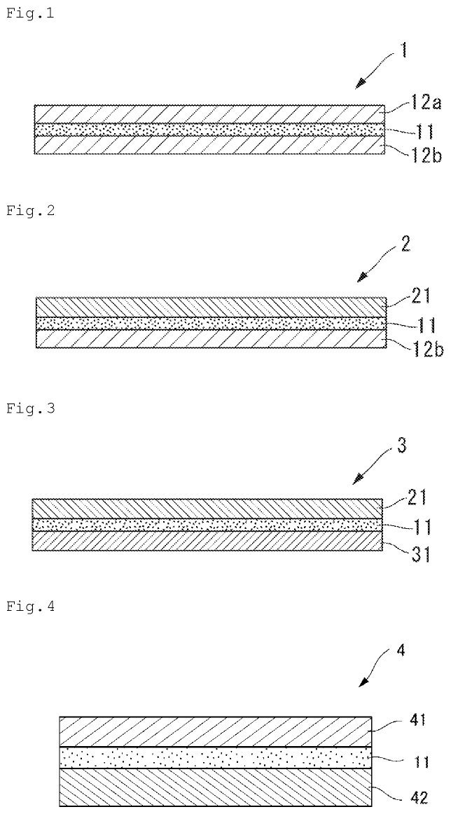

The pressure sensitive adhesive sheet according to the present embodiment has a pressure sensitive adhesive layer composed of the above-described pressure sensitive adhesive. FIG. 1 illustrates a specific configuration as an example of the pressure sensitive adhesive sheet according to the present embodiment. As illustrated in FIG. 1, a pressure sensitive adhesive sheet 1 according to an example is composed of two release sheets 12a and 12b and a pressure sensitive adhesive layer 11 interposed between the two release sheets 12a and 12b so as to be in contact with release surfaces of the two release sheets 12a and 12b. As used in the present specification, the release surface of a release sheet refers to a surface having releasability in the release sheet, and examples of the release surface include both a surface subjected to release treatment and a surface that exhibits releasability even without being subjected to release treatment.

### 1. Members

### (1) Pressure Sensitive Adhesive Layer

The pressure sensitive adhesive layer 11 is composed of the pressure sensitive adhesive according to the aforementioned embodiment and may be preferably composed of a pressure sensitive adhesive obtained by crosslinking the pressure sensitive adhesive composition P.

The thickness of the pressure sensitive adhesive layer 11 in the pressure sensitive adhesive sheet 1 according to the present embodiment may be preferably 0.1 μm or more, more preferably 1 μm or more, particularly preferably 2 μm or more, further preferably 3 μm or more, and most preferably 4 μm or more as the lower limit. This allows the pressure sensitive adhesive layer 11 to readily exhibit the desired adhesive strength and have excellent high-temperature durability.

On the other hand, the upper limit of the thickness of the above pressure sensitive adhesive layer may be preferably 1,000 μm or less, more preferably 100 μm or less, particularly preferably 30 μm or less, further preferably 10 μm or less, and most preferably 6 μm or less. This allows the pressure sensitive adhesive layer to be thin, and the thickness of the obtained display body can be reduced accordingly. In the present embodiment, even when the thickness of the pressure sensitive adhesive layer is as thin as above, the high-temperature durability is excellent.

The pressure sensitive adhesive layer 11 may be formed as a single layer or may also be formed by laminating a plurality of layers.

### (2) Release Sheets

The release sheets 12a and 12b are to protect the pressure sensitive adhesive layer 11 until the use of the pressure sensitive adhesive sheet 1 and are removed when using the pressure sensitive adhesive sheet 1 (pressure sensitive adhesive layer 11). In the pressure sensitive adhesive sheet 1 according to the present embodiment, one or both of the release sheets 12a and 12b may not necessarily be required.

Examples of the release sheets 12a and 12b for use include a polyethylene film, a polypropylene film, a polybutene film, a polybutadiene film, a polymethylpentene film, a polyvinyl chloride film, a vinyl chloride copolymer film, a polyethylene terephthalate film, a polyethylene naphthalate film, a polybutylene terephthalate film, a polyurethane film, an ethylene vinyl acetate film, an ionomer resin film, an ethylene-(meth)acrylic acid copolymer film, an ethylene-(meth)acrylic ester copolymer film, a polystyrene film, a polycarbonate film, a polyimide film, and a fluorine resin film. Crosslinked films thereof may also be used. Laminate films each obtained by laminating a plurality of such films may also be used.

It may be preferred to perform release treatment for the release surfaces (in particular, surfaces to be in contact with the pressure sensitive adhesive layer 11) of the release sheets 12a and 12b. Examples of a release agent to be used for the release treatment include alkyd-based, silicone-based, fluorine-based, unsaturated polyester-based, polyolefin-based, and wax-based release agents. One of the release sheets 12a and 12b may be preferably a tight release sheet that requires higher peeling force while the other may be an easy release sheet that requires lower peeling force.

The thickness of the release sheets 12a and 12b is not particularly limited, but may be usually about 20 to 150 μm.

### 2. Physical Properties of Pressure Sensitive Adhesive Sheet

### (1) Haze Value

The haze value of the pressure sensitive adhesive layer 11 in the present embodiment may be preferably 20% or less, particularly preferably 10% or less, and further preferably 1% or less as the upper limit. This allows the pressure sensitive adhesive layer 11 in the present embodiment to exhibit good light transmittance, and the optical laminate configured using the pressure sensitive adhesive layer 11 can readily exhibit the desired performance. On the other hand, the lower limit of the haze value of the pressure sensitive adhesive layer 11 is not particularly limited, and may be, for example, 0.1% or more in an embodiment or 0.4% or more in another embodiment. Details of the measurement method for the above haze value are as described in the Testing Example, which will be described later.

### (2) Total Luminous Transmittance

The total luminous transmittance of the pressure sensitive adhesive layer 11 in the present embodiment may be preferably 70% or more, particularly preferably 80% or more, and further preferably 90% or more as the lower limit. This allows the pressure sensitive adhesive layer 11 in the present embodiment to exhibit good light transmittance, and the optical laminate configured using the pressure sensitive adhesive layer 11 can readily exhibit the desired performance. On the other hand, the upper limit of the total luminous transmittance of the pressure sensitive adhesive layer 11 is not particularly limited, and may be, for example, 100% or less in an embodiment, 99% or less in another embodiment, or 95% or less in still another embodiment. Details of the measurement method for the above total luminous transmittance are as described in the Testing Example, which will be described later.

### (3) Adhesive Strength

The adhesive strength of the pressure sensitive adhesive sheet 1 according to the present embodiment to a non-alkali glass plate at 23° C. may be preferably 1 N/25 mm or more, particularly preferably 5 N/25 mm or more, and further preferably 9 N/25 mm as the lower limit. When the lower limit of the adhesive strength satisfies the above, the pressure sensitive adhesive sheet 1 can readily exhibit sufficient interfacial adhesion to an adherend, and the durability of the obtained optical laminate can be more excellent. In general, pressure sensitive adhesives containing plasticizers are liable to decrease in the adhesive strength, but the pressure sensitive adhesive in the present embodiment containing the aforementioned modified cyclodextrin (B) can exhibit a high adhesive strength as above. The upper limit of the above adhesive strength may be preferably 60 N/25 mm or less, more preferably 40 N/25 mm or less, particularly preferably 20 N/25 mm or less, and further preferably 15 N/25 mm or less. When the upper limit of the adhesive strength satisfies the above, good reworkability can be obtained, and the adherend can be easily reused even if a lamination error occurs.

The adhesive strength of the pressure sensitive adhesive sheet 1 according to the present embodiment to a soda-lime glass plate at 0° C. may be preferably 1 N/25 mm or more, particularly preferably 5 N/25 mm or more, and further preferably 15 N/25 mm as the lower limit. When the lower limit of the adhesive strength satisfies the above, the pressure sensitive adhesive sheet 1 can readily exhibit sufficient interfacial adhesion to an adherend even under low temperatures, and the low-temperature durability of the obtained optical laminate can be more excellent. The upper limit of the above adhesive strength may be preferably 60 N/25 mm or less, more preferably 40 N/25 mm or less, and particularly preferably 20 N/25 mm or less. When the upper limit of the adhesive strength satisfies the above, good reworkability can be obtained, and the adherend can be easily reused even if a lamination error occurs.

The adhesive strength of the pressure sensitive adhesive sheet 1 according to the present embodiment to a soda-lime glass plate at 23° C. may be preferably 1 N/25 mm or more, particularly preferably 5 N/25 mm or more, and further preferably 9 N/25 mm as the lower limit. When the lower limit of the adhesive strength satisfies the above, the pressure sensitive adhesive sheet 1 can readily exhibit sufficient interfacial adhesion to an adherend, and the durability of the obtained optical laminate can be more excellent. The upper limit of the above adhesive strength may be preferably 60 N/25 mm or less, more preferably 40 N/25 mm or less, particularly preferably 20 N/25 mm or less, and further preferably 15 N/25 mm or less. When the upper limit of the adhesive strength satisfies the above, good reworkability can be obtained, and the adherend can be easily reused even if a lamination error occurs.

The adhesive strength of the pressure sensitive adhesive sheet 1 according to the present embodiment to a soda-lime glass plate at 50° C. may be preferably 1 N/25 mm or more, particularly preferably 5 N/25 mm or more, and further preferably 10 N/25 mm as the lower limit. When the lower limit of the adhesive strength satisfies the above, the pressure sensitive adhesive sheet 1 can readily exhibit sufficient interfacial adhesion to an adherend even under high temperatures, and the high-temperature durability of the obtained optical laminate can be more excellent. The upper limit of the above adhesive strength may be preferably 60 N/25 mm or less, more preferably 40 N/25 mm or less, particularly preferably 20 N/25 mm or less, and further preferably 15 N/25 mm or less. When the upper limit of the adhesive strength satisfies the above, good reworkability can be obtained, and the adherend can be easily reused even if a lamination error occurs.

Details of the measurement method for the above adhesive strength are as described in the Testing Example, which will be described later.

### (4) 1000% Modulus

The 1000% modulus of the pressure sensitive adhesive sheet 1 according to the present embodiment when a tensile test is performed at 23° C. may be preferably 0.15 N/mm² or more, more preferably 0.25 N/mm² or more, particularly preferably 0.30 N/mm² or more, and further preferably 0.35 N/25 mm 2 or more as the lower limit. When the lower limit of the 1000% modulus falls within the above range, even if the adherend to which the pressure sensitive adhesive layer 11 constituting the pressure sensitive adhesive sheet 1 is bonded contracts due to heating, the pressure sensitive adhesive layer 11 can readily resist the contraction. This can readily and sufficiently suppress the floating or delamination of the pressure sensitive adhesive layer 11 from the adherend. On the other hand, the upper limit of the above 1000% modulus may be preferably 1.00 N/mm² or less, particularly preferably 0.80 N/mm² or less, and further preferably 0.50 N/mm² or less. When the upper limit of the 1000% modulus falls within the above range, the above-described appropriate adhesive strength can be readily exhibited. Details of the measurement method for the above 1000% modulus are as described in the Testing Example, which will be described later.

### 3. Production of Pressure Sensitive Adhesive Sheet

An example of producing the pressure sensitive adhesive sheet 1 will be described for a case in which the above pressure sensitive adhesive composition P is used. This example may include coating the release surface of one release sheet 12a (or 12b) with a coating solution of the above pressure sensitive adhesive composition P, performing heat treatment to thermally crosslink the pressure sensitive adhesive composition P to form a coating layer, and then overlapping the release surface of the other release sheet 12b (or 12a) on the coating layer. When an aging period is necessary, the above coating layer may become the pressure sensitive adhesive layer 11 after the aging period has elapsed, while when an aging period is not necessary, the above coating layer formed as such may be the pressure sensitive adhesive layer 11. The above pressure sensitive adhesive sheet 1 can thus be obtained. Conditions for the heat treatment and aging are as previously described.

Examples of the method of coating with the above coating solution of the pressure sensitive adhesive composition P include a bar coating method, a knife coating method, a roll coating method, a blade coating method, a die coating method, and a gravure coating method.

<Optical Film with Pressure Sensitive Adhesive Layer>

The optical film with pressure sensitive adhesive layer according to an embodiment of the present invention includes an optical film and a pressure sensitive adhesive layer laminated on at least one surface of the optical film. FIG. 2 illustrates a specific configuration of the optical laminate according to the present embodiment. As illustrated in FIG. 2, an optical film with pressure sensitive adhesive layer 2 according to the present embodiment may be configured to include an optical film 21, a pressure sensitive adhesive layer 11 laminated on one surface of the optical film 21, and a release sheet 12b laminated on the surface of the pressure sensitive adhesive layer 11 opposite to the optical film 21. The pressure sensitive adhesive layer 11 may be that of the aforementioned pressure sensitive adhesive sheet 1, and the release sheet 12b may also be that of the aforementioned pressure sensitive adhesive sheet 1.

Examples of the optical film 21 include a polarization plate, a retardation plate, a brightness enhancement film, a viewing angle compensation film, a contrast enhancement film, a liquid crystal polymer film, a diffusion film, a semi-transmissive reflective film, a transparent conductive film, and an anti-scattering film. Among the above, the polarization plate and the retardation plate may be preferred from the viewpoint of the effect of durability.

Examples of the polarization plate include those in which triacetyl cellulose (TAC) films as protective films are bonded to both surfaces of a polyvinyl alcohol (PVA)-based polarizer, those in which one of the above TAC films is replaced with a cycloolefin polymer film (COP polarization plate) or a polyethylene terephthalate (PET) film, and those in which a TAC film as a protective film is bonded to one surface of a PVA-based polarizer. The TAC film or films may be or may not be saponified.

To produce the optical film with pressure sensitive adhesive layer 2, as an example, one release sheet 12a of the aforementioned pressure sensitive adhesive sheet 1 is removed, and the exposed pressure sensitive adhesive layer 11 of the pressure sensitive adhesive sheet 1 is bonded to one surface of the optical film 21.

The optical film with pressure sensitive adhesive layer 2 according to the present embodiment can be used through removing the release sheet 12b and bonding the exposed pressure sensitive adhesive layer 11 to a desired optical film.

### <Optical Laminate>

FIG. 3 illustrates a specific configuration of the optical laminate according to an embodiment of the present invention. As illustrated in FIG. 3, an optical laminate 3 according to the present embodiment is configured to include a first optical film 21, a second optical film 31, and a pressure sensitive adhesive layer 11 that is located between the first optical film 21 and the second optical film 31 and bonds them to each other. The pressure sensitive adhesive layer 11 is that of the aforementioned optical film with pressure sensitive adhesive layer 2 (the pressure sensitive adhesive layer 11 of the pressure sensitive adhesive sheet 1), and the first optical film 21 is the optical film 21 of the aforementioned optical film with pressure sensitive adhesive layer 2.

The optical laminate 3 according to the present embodiment may be a display body itself or may also be a member that constitutes a part of the display body. The optical laminate 3 is not limited to them, and may be used for optical applications other than display bodies.

Examples of the above display body include liquid crystal displays (LCDs), light emitting diode (LED) displays, organic electroluminescence (organic EL) displays, and electronic paper. The display body may be a touch panel.

Examples of the first optical film 21 include the aforementioned ones, and examples of the second optical film 31 include similar ones. When the first optical film 21 is a polarization plate, the second optical film 31 may be preferably a retardation plate or a display body module (e.g., a liquid crystal (LCD) module, a light emitting diode (LED) module, an organic electro luminescence (organic EL) module, etc.). When the first optical film 21 is a retardation plate, the second optical film 31 may be preferably a polarization plate or a retardation plate.

To produce the above optical laminate 3, as an example, the release sheet 12b of the optical film with pressure sensitive adhesive layer 2 is removed, and the exposed pressure sensitive adhesive layer 11 is bonded to the second optical film 31. As another example, one release sheet 12a of the pressure sensitive adhesive sheet 1 is removed, and the exposed pressure sensitive adhesive layer 11 of the pressure sensitive adhesive sheet 1 is bonded to one surface of the first optical film 21. Subsequently, the other release sheet 12b is removed from the pressure sensitive adhesive layer 11 of the pressure sensitive adhesive sheet 1, and the exposed pressure sensitive adhesive layer 11 of the pressure sensitive adhesive sheet 1 and the second optical film 31 are bonded to each other to obtain a laminate. As still another example, the order of bonding the first optical film 21 and the second optical film 31 may be reversed.

The aforementioned embodiments are described to facilitate understanding of the present invention and are not described to limit the present invention. It is therefore intended that the elements disclosed in the above embodiments include all design changes and equivalents to fall within the technical scope of the present invention.

For example, one of the release sheets 12a and 12b in the pressure sensitive adhesive sheet 1 may be omitted. Additionally or alternatively, the release sheet 12b of the optical film with pressure sensitive adhesive layer 2 may be omitted.

### Second Embodiment

The second embodiment of the present invention will then be described.

The invention according to the second embodiment relates to a pressure sensitive adhesive sheet for devices that are repeatedly bent, a repetitive bending laminate member, and a repetitive bending device.

Before describing the invention according to the second embodiment, the background art of the invention will be described first.

In recent years, bendable displays that can be bent have been proposed as display bodies (displays) for electronic devices, which are representative of a type of device. Proposed bendable displays include those formed in a curved shape only once and repetitive bending displays for being repeatedly bent (folded).

For such a repetitive bending display as described above, it is conceivable to bond one member (bendable member) that is bendable and constitutes the bendable display to another bendable member via the pressure sensitive adhesive layer of a pressure sensitive adhesive sheet. Unfortunately, however, if the conventional pressure sensitive adhesive sheet is used for a repetitive bending display, the repeated bending may cause problems in durability, such as the occurrence of delamination at the interface between the pressure sensitive adhesive layer and an adherend in the bending portion.

Here, WO2019/026753 discloses a pressure sensitive adhesive for the purpose of suppressing the occurrence of delamination during repeated bending, etc.

Meanwhile, mobile terminals such as smartphones are used even in low-temperature environments. For example, mobile terminals used in cold regions may be exposed to temperatures below freezing. Under low-temperature environments, the pressure sensitive adhesive constituting a repetitive bending display is also cooled, and the delamination is particularly likely to occur at the interface between the pressure sensitive adhesive layer and an adherend. Such a problem of deterioration in the durability may occur not only when the repetitive bending display is repeatedly bent under a low-temperature environment, but also when the repetitive bending display is temporarily placed under a low-temperature environment and then bent under an ordinary-temperature environment. The conventional pressure sensitive adhesive as disclosed in the above-described WO2019/026753 is not sufficient in the durability under such low-temperature environments.

The invention according to the second embodiment has been made in view of the actual situations as above, and objects of the invention include providing a pressure sensitive adhesive sheet, a repetitive bending laminate member, and a repetitive bending display that are excellent in the low-temperature durability.

To achieve the above objects, first, the invention according to the second embodiment provides a pressure sensitive adhesive sheet having a pressure sensitive adhesive layer for bonding one bendable member and another bendable member that constitute a device that is repeatedly bent, wherein the pressure sensitive adhesive constituting the pressure sensitive adhesive layer contains a plasticizer, and the storage elastic modulus G′ at −25° C. of the pressure sensitive adhesive constituting the pressure sensitive adhesive layer is 0.01 MPa or more. (Invention 1).

According to the pressure sensitive adhesive sheet of the above invention (Invention 1), the pressure sensitive adhesive constituting the pressure sensitive adhesive layer contains a plasticizer, and the storage elastic modulus G′ at −25° C. of the pressure sensitive adhesive falls within the above range. It is thereby possible to produce a repetitive bending device having excellent durability even under low-temperature environments.

In the above invention (Invention 1), the plasticizer may be preferably at least one of a modified cyclodextrin and a citric acid-based plasticizer (Invention 2).

In the above invention (Invention 2), the degree of modification of the modified cyclodextrin may be preferably 2.5 or more and 3.0 or less (Invention 3).

In the above invention (Invention 1 to 3), the pressure sensitive adhesive may preferably contain a crosslinked product obtained by crosslinking a (meth)acrylic ester polymer with a crosslinker (Invention 4).

In the above invention (Invention 1 to 4), the storage elastic modulus G′ at −25° C. of the pressure sensitive adhesive constituting the pressure sensitive adhesive layer may be preferably 0.2 MPa or more (Invention 5).

In the above invention (Invention 1 to 5), the pressure sensitive adhesive sheet may preferably include two release sheets, and the pressure sensitive adhesive layer may be preferably interposed between the two release sheets so as to be in contact with the release surfaces of the two release sheets (Invention 6).

Second, the present invention provides a repetitive bending laminate member comprising: a bendable member and another bendable member that constitute a repetitive bending device; and a pressure sensitive adhesive layer that bonds the bendable member and the other bendable member to each other, wherein the pressure sensitive adhesive layer is that of the pressure sensitive adhesive sheet (Invention 1 to 6) (Invention 7).

Third, the present invention provides a repetitive bending device including the repetitive bending laminate member (Invention 7) (Invention 8).

The pressure sensitive adhesive sheet, repetitive bending laminate member, and repetitive bending device according to the above invention of the second embodiment are excellent in the low-temperature durability.

The second embodiment of the present invention will be described below.

### <Pressure Sensitive Adhesive Sheet>

The pressure sensitive adhesive sheet according to an embodiment of the present invention has a pressure sensitive adhesive layer for bonding a repetitive bending laminate member and another repetitive bending laminate member that constitute a repetitive bending device, and may be preferably obtained by laminating a release sheet on one surface of the pressure sensitive adhesive layer or laminating release sheets on both surfaces of the pressure sensitive adhesive layer.

In the pressure sensitive adhesive sheet according to the present embodiment, the pressure sensitive adhesive constituting the pressure sensitive adhesive layer contains a plasticizer. Furthermore, the storage elastic modulus G′ at −25° C. of the pressure sensitive adhesive is 0.01 MPa or more.

The pressure sensitive adhesive constituting the pressure sensitive adhesive layer in the present embodiment contains a plasticizer as described above, and the pressure sensitive adhesive layer can thereby maintain the desired flexibility even when placed under low-temperature environments. Furthermore, the storage elastic modulus G′ at −25° C. of the pressure sensitive adhesive falls within the above range, and the pressure sensitive adhesive layer can thereby maintain the desired cohesive force even when placed under low-temperature environments. As a result of these effects acting in a synergistic manner, the repetitive bending device produced using the pressure sensitive adhesive sheet according to the present embodiment can be excellent in the durability against bending under low-temperature environments (such durability may be simply referred to as “low-temperature durability,” hereinafter). Specifically, when a laminate obtained by bonding the bendable member and the other bendable member via the pressure sensitive adhesive layer is repeatedly bent under a low-temperature environment, it is possible to suppress the occurrence of delamination at the interface between the pressure sensitive adhesive layer and an adherend in the bending portion.

As used in the present specification, temperatures “under low-temperature environments” refer, for example, to 0° C. or lower in an embodiment, −20° C. or lower in another embodiment, or −30° C. or lower in still another embodiment. On the other hand, although the lower limit of the above temperatures is not particularly limited, it refers to a temperature of −80° C. or higher, for example.

From the viewpoint of obtaining the low-temperature durability described above more effectively, the storage elastic modulus G′ at −25° C. of the pressure sensitive adhesive constituting the pressure sensitive adhesive layer in the present embodiment may be preferably 0.05 MPa or more, particularly preferably 0.07 MPa or more, and further preferably 0.08 MPa or more. From the viewpoint of readily suppressing the deterioration in bending resistance due to reduced flexibility of the pressure sensitive adhesive at low temperatures, the upper limit of the storage elastic modulus G′ may be preferably 0.2 MPa or less, particularly preferably 0.14 MPa or less, and further preferably 0.09 MPa or less.

Additionally or alternatively, the storage elastic modulus G′ at 0° C. of the pressure sensitive adhesive constituting the pressure sensitive adhesive layer in the present embodiment may be preferably 0.01 MPa or more, particularly preferably 0.02 MPa or more, and further preferably 0.04 MPa or more. From another aspect, the storage elastic modulus G′ may be preferably 0.15 MPa or less, particularly preferably 0.1 MPa or less, and further preferably 0.08 MPa or less. When the storage elastic modulus G′ at 0° C. falls within the above range, the pressure sensitive adhesive constituting the pressure sensitive adhesive layer in the present embodiment can readily satisfy the aforementioned storage elastic modulus G′ at −25° C.

Additionally or alternatively, the storage elastic modulus G′ at 23° C. of the pressure sensitive adhesive constituting the pressure sensitive adhesive layer in the present embodiment may be preferably 0.01 MPa or more, particularly preferably 0.02 MPa or more, and further preferably 0.03 MPa or more. From another aspect, the storage elastic modulus G′ may be preferably 0.10 MPa or less, particularly preferably 0.08 MPa or less, and further preferably 0.04 MPa or less. When the storage elastic modulus G′ at 23° C. falls within the above range, the pressure sensitive adhesive constituting the pressure sensitive adhesive layer in the present embodiment can readily achieve both the good handling properties and the bending resistance at ordinary temperatures.

Additionally or alternatively, the storage elastic modulus G′ at 40° C. of the pressure sensitive adhesive constituting the pressure sensitive adhesive layer in the present embodiment may be preferably 0.010 MPa or more, particularly preferably 0.018 MPa or more, and further preferably 0.020 MPa or more. From another aspect, the storage elastic modulus G′ may be preferably 0.08 MPa or less, particularly preferably 0.06 MPa or less, and further preferably 0.04 MPa or less. When the storage elastic modulus G′ at 40° C. falls within the above range, the pressure sensitive adhesive constituting the pressure sensitive adhesive layer in the present embodiment can readily have excellent durability against bending even under high-temperature environments.

Details of the measurement method for the storage elastic modulus G′ at the above-described temperatures are as described in the Testing Example, which will be described later.

FIG. 1 illustrates a specific configuration as an example of the pressure sensitive adhesive sheet according to the present embodiment. As illustrated in FIG. 1, a pressure sensitive adhesive sheet 1 according to an embodiment is composed of two release sheets 12a and 12b and a pressure sensitive adhesive layer 11 interposed between the two release sheets 12a and 12b so as to be in contact with release surfaces of the two release sheets 12a and 12b.

### 1. Constitutional Elements

### 1-1. Pressure Sensitive Adhesive Layer

The pressure sensitive adhesive layer 11 is not particularly limited, provided that it is composed of a pressure sensitive adhesive that contains a plasticizer and has the aforementioned physical properties. For example, the pressure sensitive adhesive may be any of an acrylic-based pressure sensitive adhesive, a polyester-based pressure sensitive adhesive, a polyurethane-based pressure sensitive adhesive, a rubber-based pressure sensitive adhesive, a silicone-based pressure sensitive adhesive, etc. The pressure sensitive adhesive may be any of emulsion type, solvent type, or non-solvent type and may also be crosslinked type or non-crosslinked type. Among these, acrylic-based pressure sensitive adhesives may be preferred because they are excellent in the pressure sensitive adhesive physical properties, optical properties, etc. As the acrylic-based pressure sensitive adhesives, crosslinking type ones may be preferred, and thermal crosslinking type ones may be further preferred.

The pressure sensitive adhesive constituting the pressure sensitive adhesive layer 11 may be non-curable with active energy rays or curable with active energy rays. When the pressure sensitive adhesive in the present embodiment is non-curable with active energy rays, the pressure sensitive adhesive may be preferably one obtained by crosslinking a pressure sensitive adhesive composition that contains a (meth)acrylic ester polymer (A), a plasticizer (B), and a crosslinker (C) and optionally a silane coupling agent (D) (such a pressure sensitive adhesive composition may be referred to as a “pressure sensitive adhesive composition P,” hereinafter). This allows the pressure sensitive adhesive constituting the pressure sensitive adhesive layer 11 to contain a crosslinked product obtained by crosslinking the (meth)acrylic ester polymer with the crosslinker.

### (1) Components of Pressure Sensitive Adhesive Composition P

### (1-1) (Meth)acrylic Ester Polymer (A)

The (meth)acrylic ester polymer (A) in the present embodiment may preferably contain, as a monomer unit that constitutes the polymer, a reactive group-containing monomer having in the molecule a reactive group that reacts with the crosslinker (C). The reactive group derived from the reactive group-containing monomer reacts with the crosslinker (C) to form a crosslinked structure (three-dimensional network structure), and the pressure sensitive adhesive to be obtained can further readily satisfy the aforementioned storage elastic modulus G′.

Examples of the above reactive group-containing monomer include the same ones as described in the invention according to the first embodiment. In particular, preferred examples of hydroxyl group-containing monomers, carboxy group-containing monomers, and amino group-containing monomers are the same as those in the invention according to the first embodiment.

The (meth)acrylic ester polymer (A) may preferably contain, as the lower limit, 0.1 mass % or more, particularly preferably 1 mass % or more, and further preferably 1.6 mass % or more of the reactive group-containing monomer as a monomer unit that constitutes the polymer. From another aspect, the (meth)acrylic ester polymer (A) may preferably contain, as the upper limit, 20 mass % or less, more preferably 10 mass % or less, preferably 6 mass % or less, and further preferably 3 mass % or less of the reactive group-containing monomer as a monomer unit that constitutes the polymer. When the (meth)acrylic ester polymer (A) contains the reactive group-containing monomer in the above amount as a monomer unit, a good crosslinked structure is formed in the obtained pressure sensitive adhesive, and the obtained pressure sensitive adhesive can readily satisfy the aforementioned storage elastic modulus G′.

As in the invention according to the first embodiment, the (meth)acrylic ester polymer (A) in the second embodiment may preferably contain (meth)acrylic alkyl ester as a monomer unit that constitutes the polymer. The specific examples may also be the same as those in the invention according to the first embodiment. In the second embodiment, however, from the viewpoint of further improving the pressure sensitive adhesive properties, (meth)acrylic ester whose carbon number of alkyl group is 4 to 10 may be preferred. Considering the viewpoint that the storage elastic modulus at low temperatures can be readily set to a lower value, (meth)acrylic ester whose carbon number of alkyl group is 6 to 8 may be further preferred. For example, 2-ethylhexyl (meth)acrylate or isooctyl (meth)acrylate may be preferred.

The (meth)acrylic ester polymer (A) may preferably contain 80 mass % or more, more preferably 90 mass % or more, particularly preferably 94 mass % or more, and further preferably 97 mass % or more of the (meth)acrylic alkyl ester as a monomer unit that constitutes the polymer. When the lower limit of the content of the (meth)acrylic alkyl ester satisfies the above, the pressure sensitive adhesive can be readily obtained with a lowered storage elastic modulus at low temperatures and excellent pressure sensitive adhesive properties. On the other hand, the (meth)acrylic ester polymer (A) may preferably contain 99.9 mass % or less, particularly preferably 99.0 mass % or less, and further preferably 98.4 mass % or less of the (meth)acrylic alkyl ester. When the upper limit of the content of the (meth)acrylic alkyl ester satisfies the above, a desired amount of other monomers such as a reactive functional group-containing monomer can be readily introduced into the (meth)acrylic ester polymer (A).

If desired, as in the invention according to the first embodiment, the (meth)acrylic ester polymer (A) in the second embodiment may contain other monomers as monomer units that constitute the polymer. The specific examples may also be the same as those in the invention according to the first embodiment.

The (meth)acrylic ester polymer (A) may be preferably a linear polymer. Such a linear polymer may promote the entanglement of molecular chains, and improvement in the cohesive force can be expected, so the storage elastic modulus at high temperatures can be readily maintained high while the storage elastic modulus at low temperatures is suppressed to a low value.

The (meth)acrylic ester polymer (A) may be preferably a solution polymerization product obtained by a solution polymerization method. Being a solution polymerization product allows a high molecular-weight polymer to be readily obtained, and improvement in the cohesive force can be expected, so the storage elastic modulus at high temperatures can be readily maintained high while the storage elastic modulus at low temperatures is suppressed to a low value.

The polymerization form of the (meth)acrylic ester polymer (A) may be a random copolymer or may also be a block copolymer.

The weight-average molecular weight of the (meth)acrylic ester polymer (A) may be preferably 300,000 or more, more preferably 600,000 or more, particularly preferably 800,000 or more, and further preferably 1,000,000 or more from the viewpoint of making molecules of the (meth)acrylic ester polymer (A) sufficiently entangled with each other so that the aforementioned gel fraction can be readily achieved. From the same viewpoint, the weight-average molecular weight of the (meth)acrylic ester polymer (A) may be preferably 2,000,000 or less, particularly preferably 1,800,000 or less, and further preferably 1,400,000 or less. As used in the present specification, the weight-average molecular weight refers to a standard polystyrene equivalent value that is measured by using a gel permeation chromatography (GPC) method.

In the pressure sensitive adhesive composition P, one type of the (meth)acrylic ester polymer (A) may be used alone or two or more types may also be used in combination.

### (1-2) Plasticizer (B)

The plasticizer (B) in the present embodiment is not particularly limited, provided that it can impart plasticity to the pressure sensitive adhesive. For example, the plasticizer (B) in the present embodiment may be preferably at least one of modified cyclodextrin and citric acid-based plasticizer.

Preferred aspects of the modified cyclodextrin in the second embodiment may be the same as those in the first embodiment. However, the degree of modification of the modified cyclodextrin in the second embodiment may be preferably 2.5 or more, particularly preferably 2.7 or more, and further preferably 2.8 or more. When the degree of modification of the modified cyclodextrin falls within the above range, better plasticity can be readily imparted to the pressure sensitive adhesive. Although the upper limit of the above degree of modification is not particularly limited, it may be 3.0 or less in an embodiment, 2.99 or less in another embodiment, or 2.98 or less in still another embodiment.

On the other hand, preferred examples of the citric acid-based plasticizer in the present embodiment include triethyl citrate (TEC), tributyl citrate (TBC), acetyl triethyl citrate (ATEC), and acetyl tributyl citrate (ATBC). Among these, acetyl tributyl citrate may be preferred from the viewpoint of readily imparting better plasticity to the pressure sensitive adhesive.

In the pressure sensitive adhesive composition P, one type of the plasticizer (B) may be used alone or two or more types may also be used in combination.

The content of the plasticizer (B) in the pressure sensitive adhesive composition P may be preferably 0.1 mass parts or more, more preferably 1 mass part or more, particularly preferably 4 mass parts or more, and further preferably 8 mass parts or more with respect to 100 mass parts of the (meth)acrylic ester polymer (A). From another aspect, the content of the plasticizer (B) in the pressure sensitive adhesive composition P may be preferably 50 mass parts or less, particularly preferably 30 mass parts or less, and further preferably 15 mass parts or less with respect to 100 mass parts of the (meth)acrylic ester polymer (A). When the content of the plasticizer (B) with respect to 100 mass parts of the (meth)acrylic ester polymer (A) is 0.1 mass parts or more, the pressure sensitive adhesive according to the present embodiment can exhibit better plasticity. When the above content is 50 mass parts or less, the pressure sensitive adhesive according to the present embodiment can readily exhibit the desired adhesive strength.

### (1-3) Crosslinker (C)

Preferred examples of the crosslinker (C) in the second embodiment may be the same as those in the first embodiment. In the second embodiment, however, the content of the crosslinker (C) in the pressure sensitive adhesive composition P may be preferably 0.001 mass parts or more, particularly preferably 0.01 mass parts or more, further preferably 0.1 mass parts or more, and most preferably 0.5 mass parts or more with respect to 100 mass parts of the (meth)acrylic ester polymer (A). From another aspect, the content of the crosslinker (C) may be preferably 10 mass parts or less, particularly preferably 5 mass parts or less, and further preferably 1 mass part or less. When the content of the crosslinker (B) falls within the above range, the desired adhesive strength and the aforementioned storage elastic modulus G′ can be readily achieved.

### (1-4) Silane Coupling Agent (D)

Preferred examples of the silane coupling agent (D) in the second embodiment may be the same as those in the first embodiment. The content of the silane coupling agent (D) may also be the same as that in the first embodiment.

### (1-5) Various Additives

Also in the second embodiment, the pressure sensitive adhesive composition P may contain additives as in the first embodiment.

### (2) Production of Pressure Sensitive Adhesive Composition P

The pressure sensitive adhesive composition P can be prepared through producing the (meth)acrylic ester polymer (A) and mixing the obtained (meth)acrylic ester polymer (A) with the plasticizer (B) and the crosslinker (C) and optionally adding the silane coupling agent (D), other additives, etc.

The above (meth)acrylate polymer (A) can be produced in the same manner as in the first embodiment. After the (meth)acrylic ester polymer (A) is obtained, the pressure sensitive adhesive composition P (coating solution) diluted with a solvent may be obtained through adding the modified cyclodextrin (B) and the crosslinker (C) and optionally a diluent solvent, the silane coupling agent (D), other additives, etc. to the solution of the (meth)acrylic ester polymer (A) and sufficiently mixing them. If any of the above components is in the form of a solid, or if precipitation occurs when the component is mixed with another component in an undiluted state, the component may be preliminarily dissolved in or diluted with a diluent solvent alone and then mixed with the other component.

The specific examples of the above diluent solvent, the concentration/viscosity of the prepared coating solution, and the necessity of adding the diluent solvent and the like may be the same as those in the first embodiment.

### (3) Production of Pressure Sensitive Adhesive

The method of obtaining the pressure sensitive adhesive from the above pressure sensitive adhesive composition P may be the same as that in the first embodiment.

### (4) Physical Properties of Pressure Sensitive Adhesive Layer

The gel fraction of the pressure sensitive adhesive constituting the pressure sensitive adhesive layer 11 in the present embodiment may be preferably 10% or more, more preferably 30% or more, particularly preferably 50% or more, and further preferably 60% or more. When the above gel fraction is 10% or more, the pressure sensitive adhesive in the present embodiment has a high cohesive force and can readily satisfy the aforementioned storage elastic modulus G′. The upper limit of the gel fraction of the pressure sensitive adhesive according to the present embodiment is not particularly limited, and may be, for example, 100% or less in an embodiment, 90% or less in another embodiment, or 80% or less in still another embodiment. Details of the measurement method for the above gel fraction are as described in the Testing Example, which will be described later.

The thickness of the pressure sensitive adhesive layer 11 in the present embodiment may be preferably 1 μm or more, more preferably 5 μm or more, particularly preferably 10 μm or more, further preferably 15 μm or more, and most preferably 20 μm or more as the lower limit. This allows the pressure sensitive adhesive layer 11 to exhibit a desired adhesive strength.

On the other hand, the upper limit of the thickness of the pressure sensitive adhesive layer 11 may be preferably 1,000 μm or less, more preferably 100 μm or less, particularly preferably 80 μm or less, further preferably 55 μm or less, and most preferably 35 μm or less. This allows the pressure sensitive adhesive layer 11 to achieve excellent durability against repeated bending.

### 1-2. Release Sheets

The same release sheets as those in the first embodiment can be used in the second embodiment.

### 2. Physical Properties

### (1) Haze Value

The haze value (normal haze value) of the pressure sensitive adhesive layer 11 in the present embodiment may be preferably 20% or less, more preferably 10% or less, particularly preferably 6% or less, and further preferably 4% or less as the upper limit. This allows the pressure sensitive adhesive layer 11 in the present embodiment to exhibit good light transmittance, and the repetitive bending device configured using the pressure sensitive adhesive layer 11 can readily exhibit the desired performance. On the other hand, the lower limit of the haze value (normal haze value) of the pressure sensitive adhesive layer 11 is not particularly limited, and may be, for example, 0.1% or more in an embodiment or 0.4% or more in another embodiment. Details of the measurement method for the above normal haze value are as described in the Testing Example, which will be described later.

Additionally or alternatively, the haze value of the pressure sensitive adhesive layer 11 in the present embodiment after leaving it untouched under an environment of −20° C. for 72 hours (haze value after 72 hours at −20° C.) may be preferably 20% or less, more preferably 10% or less, particularly preferably 6% or less, and further preferably 4% or less. This allows the pressure sensitive adhesive layer 11 in the present embodiment to exhibit good light transmittance even when placed under low-temperature conditions, and the repetitive bending device configured using the pressure sensitive adhesive layer 11 can readily exhibit the desired performance. On the other hand, the lower limit of the above haze value (haze value after 72 hours at −20° C.) of the pressure sensitive adhesive layer 11 is not particularly limited, and may be, for example, 0.1% or more in an embodiment or 0.4% or more in another embodiment. Details of the measurement method for the above haze value (haze value after 72 hours at −20° C.) are as described in the Testing Example, which will be described later.

The absolute value (Δhaze) of a value obtained by subtracting the haze value after 72 hours at −20° C. from the normal haze value of the pressure sensitive adhesive layer 11 in the present embodiment may be preferably 10 points or less, particularly preferably 5 points or less, and further preferably 1 point or less. When the Δhaze is 10 points or less, the pressure sensitive adhesive layer 11 in the present embodiment is less likely to cause a difference in the light transmittance between the ordinary-temperature environments and the low-temperature environments, and the repetitive bending device configured using the pressure sensitive adhesive layer 11 can readily exhibit the desired performance. On the other hand, the lower limit of the Δhaze is not particularly limited, and may be 0 points or more, for example.

### (2) Total Luminous Transmittance

The total luminous transmittance of the pressure sensitive adhesive layer 11 in the present embodiment may be preferably 70% or more, particularly preferably 80% or more, and further preferably 90% or more as the lower limit. This allows the pressure sensitive adhesive layer 11 in the present embodiment to exhibit good light transmittance, and the repetitive bending device configured using the pressure sensitive adhesive layer 11 can readily exhibit the desired performance. On the other hand, the upper limit of the total luminous transmittance of the pressure sensitive adhesive layer 11 is not particularly limited, and may be, for example, 100% or less in an embodiment, 99% or less in another embodiment, or 95% or less in still another embodiment. Details of the measurement method for the above total luminous transmittance are as described in the Testing Example, which will be described later.

### (3) Adhesive Strength

The adhesive strength of the pressure sensitive adhesive sheet 1 according to the present embodiment to a non-alkali glass plate at 23° C. may be preferably 0.1 N/25 mm or more, particularly preferably 0.5 N/25 mm or more, and further preferably 3 N/25 mm as the lower limit. When the lower limit of the adhesive strength satisfies the above, the pressure sensitive adhesive sheet 1 can readily exhibit sufficient interfacial adhesion to an adherend, and the low-temperature durability of the obtained repetitive bending device can be more excellent. The upper limit of the above adhesive strength may be preferably 60 N/25 mm or less, more preferably 40 N/25 mm or less, particularly preferably 20 N/25 mm or less, and further preferably 15 N/25 mm or less. When the upper limit of the adhesive strength satisfies the above, good reworkability can be obtained, and the adherend can be easily reused even if a lamination error occurs. Details of the measurement method for the above adhesive strength are as described in the Testing Example, which will be described later.

### 3. Production of Pressure Sensitive Adhesive Sheet

The pressure sensitive adhesive sheet in the second embodiment can be produced in the same manner as in the first embodiment.

### <Repetitive Bending Laminate Member>

As illustrated in FIG. 4, a repetitive bending laminate member 4 according to the present embodiment is configured to include a first bendable member 41 (a bendable member), a second bendable member 42 (another bendable member), and a pressure sensitive adhesive layer 11 that is located between the first bendable member 41 and the second bendable member 42 and bonds them to each other.

The pressure sensitive adhesive layer 11 in the above repetitive bending laminate member 4 is that of the aforementioned pressure sensitive adhesive sheet 1.

The repetitive bending laminate member 4 may be a repetitive bending device itself or may also be a member constituting a part of the repetitive bending device. The repetitive bending device may be preferably, but is not limited to, a display that can be repeatedly bent (including being folded) (repetitive bending display). Examples of such repetitive bending devices include organic electroluminescence (organic EL) displays, electrophoretic displays (electronic paper), liquid crystal displays using plastic substrates (films) as the substrates, and foldable displays. The repetitive bending devices may be touch panels.

The first bendable member 41 and the second bendable member 42 may be members that can be repeatedly bent (including being folded), and examples thereof include cover films, gas barrier films, hard coat films, polarization films (polarization plates), polarizers, retardation films (retardation plates), viewing angle compensation films, brightness enhancement films, contrast enhancement films, diffusion films, semi-transmissive reflective films, electrode films, transparent conductive films, metal mesh films, flexible glass, film sensors (touch sensor films), liquid crystal polymer films, luminescent polymer films, film-like liquid crystal modules, organic EL modules (organic EL films, organic EL elements), electronic paper modules (film-like electronic paper), and thin film transistor (TFT) substrates.

At least one of the first bendable member 41 and the second bendable member 42 may be a polyimide film or a laminate including a polyimide film on the pressure sensitive adhesive layer 11 side. A polyimide film generally has low interfacial adhesion with a pressure sensitive adhesive layer, but according to the pressure sensitive adhesive layer 11 of the present embodiment, even when the polyimide film is an adherend, excellent low-temperature durability can be obtained.

The Young's moduli of the first bendable member 41 and second bendable member 42 may each be preferably 0.1 to 10 GPa, particularly preferably 0.5 to 7 GPa, and further preferably 1.0 to 5 GPa. When the Young's moduli of the first bendable member 41 and second bendable member 42 fall within such ranges, each bendable member can be readily bent repeatedly.

Additionally or alternatively, when each of the first bendable member 41 and the second bendable member 42 has an angle (a folding angle on the acute angle side formed between the surfaces of the bendable members) at which it can be folded without cracking or irreversible deformation when folded at its center line, the angle may be preferably 150° or less, more preferably 90° or less, particularly preferably 60° or less, further preferably 30° or less, and most preferably 10° or less. This allows the repetitive bending device to be readily obtained, which will be described later.

The thickness of each of the first bendable member 41 and the second bendable member 42 may be preferably 10 to 3,000 μm, particularly preferably 25 to 1,000 μm, and further preferably 50 to 500 μm. When the thicknesses of the first bendable member 41 and second bendable member 42 fall within such ranges, it may be easy to repeatedly bend each bendable member.

To produce the above repetitive bending laminate member 2, as an example, one release sheet 12a of the pressure sensitive adhesive sheet 1 is removed, and the exposed pressure sensitive adhesive layer 11 of the pressure sensitive adhesive sheet 1 is bonded to one surface of the first bendable member 41.

After that, the other release sheet 12b is removed from the pressure sensitive adhesive layer 11 of the pressure sensitive adhesive sheet 1, and the exposed pressure sensitive adhesive layer 11 of the pressure sensitive adhesive sheet 1 and the second bendable member 42 are bonded to each other to obtain the repetitive bending laminate member 4. As another example, the order of bonding the first bendable member 41 and the second bendable member 42 may be reversed.

### <Repetitive Bending Device>

The repetitive bending device according to the present embodiment, which includes the above repetitive bending laminate member 4, may be composed only of the repetitive bending laminate member 4 or may also be configured to include one or more repetitive bending laminate members 4 and another bendable member. When a repetitive bending laminate member 4 and another repetitive bending laminate member 4 are laminated or when a repetitive bending laminate member 4 and another bendable member are laminated, it may be preferred to laminate them via the pressure sensitive adhesive layer 11 of the aforementioned pressure sensitive adhesive sheet 1.

The repetitive bending device according to the present embodiment has excellent low-temperature durability because the pressure sensitive adhesive layer is composed of the aforementioned pressure sensitive adhesive.

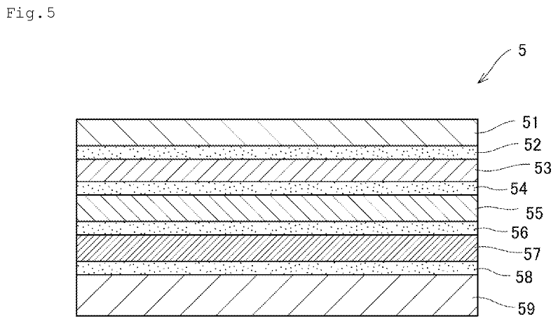

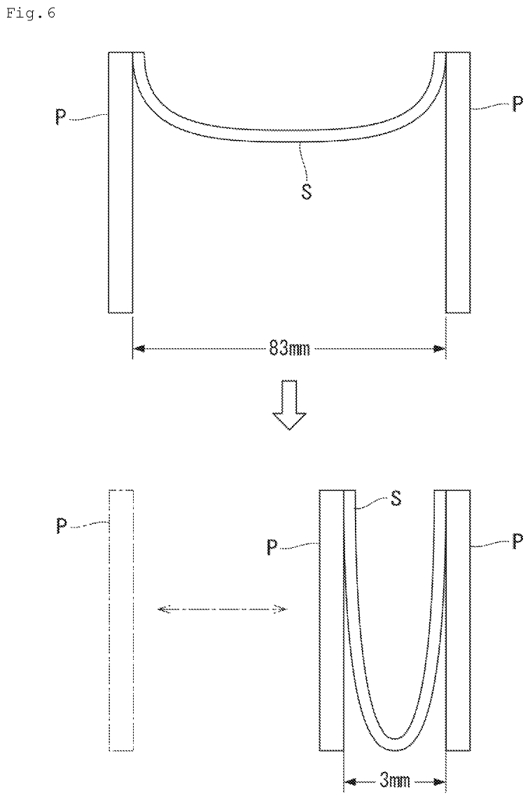

FIG. 5 illustrates a repetitive bending device as an example in the present embodiment. The repetitive bending device according to the present invention is not limited to that repetitive bending device.

As illustrated in FIG. 5, a repetitive bending device according to the present embodiment may be configured by laminating a cover film 51, a first pressure sensitive adhesive layer 52, a polarization film 53, a second pressure sensitive adhesive layer 54, a touch sensor film 55, a third pressure sensitive adhesive layer 56, an organic EL element 57, a fourth pressure sensitive adhesive layer 58, and a TFT substrate 59 in this order from the top. The above cover film 51, polarization film 53, touch sensor film 55, organic EL element 57, and TFT substrate 59 correspond to bendable members.

At least one of the first pressure sensitive adhesive layer 52, the second pressure sensitive adhesive layer 54, the third pressure sensitive adhesive layer 56, and the fourth pressure sensitive adhesive layer 58 may be the pressure sensitive adhesive layer 11 of the aforementioned pressure sensitive adhesive sheet 1. Any two or more of the first pressure sensitive adhesive layer 52, the second pressure sensitive adhesive layer 54, the third pressure sensitive adhesive layer 56, and the fourth pressure sensitive adhesive layer 58 may each be preferably the pressure sensitive adhesive layer 11 of the aforementioned pressure sensitive adhesive sheet 1. Most preferably, all of the pressure sensitive adhesive layers 32, 34, 36, and 38 are each the pressure sensitive adhesive layer 11 of the pressure sensitive adhesive sheet 1.

The aforementioned embodiments are described to facilitate understanding of the present invention and are not described to limit the present invention. It is therefore intended that the elements disclosed in the above embodiments include all design changes and equivalents to fall within the technical scope of the present invention.

For example, one or both of the release sheets 12a and 12b in the pressure sensitive adhesive sheet 1 may be omitted, and one or more desired bendable members may be laminated as substitute for the release sheets 12a and/or 12b.

### Third Embodiment

The third embodiment of the present invention will then be described.

The invention according to the third embodiment relates to a pressure sensitive adhesive sheet for devices that are repeatedly bent, a repetitive bending laminate member, and a repetitive bending device.

Before describing the invention according to the third embodiment, the background art of the invention will be described first.

As described in the second embodiment, in recent years, repetitive bending devices have been proposed, but under low-temperature environments, the pressure sensitive adhesive constituting a repetitive bending display is also cooled, and the delamination is particularly likely to occur at the interface between the pressure sensitive adhesive layer and an adherend. Such a problem of deterioration in the durability may occur not only when the repetitive bending display is repeatedly bent under a low-temperature environment, but also when the repetitive bending display is temporarily placed under a low-temperature environment and then bent under an ordinary-temperature environment.

In addition, mobile terminals may come to a high-temperature state due to heat from members that generate heat, such as processors and batteries. In this case, the pressure sensitive adhesive constituting a repetitive bending display is heated, so that delamination is liable to occur at the interface between the pressure sensitive adhesive layer and the adherend.

The conventional pressure sensitive adhesive as disclosed in the aforementioned WO2019/026753 is not sufficient in the durability under low-temperature environments or high-temperature environments.

The invention according to the third embodiment has been made in view of the actual situations as above, and objects of the invention include providing a pressure sensitive adhesive sheet, a repetitive bending laminate member, and a repetitive bending display that are excellent in the durability under a wide range of temperature environments from low to high temperatures.

To achieve the above objects, first, the present invention provides a pressure sensitive adhesive sheet having a pressure sensitive adhesive layer for bonding one bendable member and another bendable member that constitute a device that is repeatedly bent, wherein the 100% modulus of the pressure sensitive adhesive constituting the pressure sensitive adhesive layer is 0.048 N/mm² or less, the breaking elongation of the pressure sensitive adhesive constituting the pressure sensitive adhesive layer is 650% or more in a tensile test, and the breaking stress of the pressure sensitive adhesive constituting the pressure sensitive adhesive layer is 0.15 N/mm² or more in a tensile test (Invention 1).

According to the pressure sensitive adhesive sheet of the above invention (Invention 1), the pressure sensitive adhesive layer is composed of the pressure sensitive adhesive exhibiting the above-described 100% modulus, breaking elongation, and breaking stress, and it is thereby possible to produce a repetitive bending device having excellent durability under a wide range of environments of low temperatures, ordinary temperatures, and high temperatures.

In the above invention (Invention 1), the pressure sensitive adhesive constituting the pressure sensitive adhesive layer may preferably contain a plasticizer (Invention 2).

In the above invention (Invention 2), the plasticizer may be preferably a modified cyclodextrin (Invention 3).

In the above invention (Invention 2, 3), the molecular weight of the plasticizer may be preferably 1,500 or more and 50,000 or less (Invention 4).

In the above invention (Invention 1 to 4), the pressure sensitive adhesive constituting the pressure sensitive adhesive layer may preferably contain a crosslinked product obtained by crosslinking a (meth)acrylic ester polymer with a crosslinker (Invention 5).

In the above invention (Invention 1 to 5), the pressure sensitive adhesive sheet may preferably include two release sheets, and the pressure sensitive adhesive layer may be preferably interposed between the two release sheets so as to be in contact with the release surfaces of the two release sheets (Invention 6).

Second, the present invention provides a repetitive bending laminate member comprising: a bendable member and another bendable member that constitute a repetitive bending device; and a pressure sensitive adhesive layer that bonds the bendable member and the other bendable member to each other, wherein the pressure sensitive adhesive layer is that of the pressure sensitive adhesive sheet (Invention 1 to 6) (Invention 7).

Third, the present invention provides a repetitive bending device including the repetitive bending laminate member (Invention 7) (Invention 8).

The pressure sensitive adhesive sheet, repetitive bending laminate member, and repetitive bending device according to the invention of the third embodiment are excellent in the durability under a wide range of temperature environments from low to high temperatures.

The third embodiment of the present invention will be described below.

### <Pressure Sensitive Adhesive Sheet>

The pressure sensitive adhesive sheet according to an embodiment of the present invention has a pressure sensitive adhesive layer for bonding a repetitive bending laminate member and another repetitive bending laminate member that constitute a repetitive bending device, and may be preferably obtained by laminating a release sheet on one surface of the pressure sensitive adhesive layer or laminating release sheets on both surfaces of the pressure sensitive adhesive layer.

In the pressure sensitive adhesive sheet according to the present embodiment, the 100% modulus of the pressure sensitive adhesive constituting the pressure sensitive adhesive layer is 0.048 N/mm² or less, the breaking elongation of the pressure sensitive adhesive constituting the pressure sensitive adhesive layer is 650% or more in a tensile test, and the breaking stress of the pressure sensitive adhesive constituting the pressure sensitive adhesive layer is 0.15 N/mm² or more in a tensile test.

The pressure sensitive adhesive exhibiting these physical properties can well achieve both the desired flexibility and the desired cohesive strength under ordinary-temperature environments such as 23° C. As a result of these effects acting in a synergistic manner, the repetitive bending device produced using the pressure sensitive adhesive sheet according to the present embodiment can be excellent in the durability against repetitive bending under environments from low to high temperatures. That is, when a laminate obtained by bonding the bendable member and the other bendable member via the pressure sensitive adhesive layer in the present embodiment is repeatedly bent under an environment from low to high temperatures, delamination is less likely to occur at the interface between the pressure sensitive adhesive layer and an adherend in the bending portion.

As used in the present specification, temperatures “under high-temperature environments” refer, for example, to 60° C. or higher in an embodiment, 70° C. or higher in another embodiment, or 80° C. or higher in still another embodiment. On the other hand, although the upper limit of the above temperatures is not particularly limited, it refers to a temperature of 180° C. or lower, for example.

From the viewpoint of more effectively obtaining the durability from low temperatures to ordinary temperatures, the 100% modulus of the pressure sensitive adhesive constituting the pressure sensitive adhesive layer in the present embodiment may be preferably 0.046 N/mm² or less, particularly preferably 0.044 N/mm² or less, and further preferably 0.015 N/mm² or less. Although the lower limit of the 100% modulus is not particularly limited, it may be preferably 0.001 N/mm² or more, particularly preferably 0.005 N/mm² or more, and further preferably 0.008 N/mm² or more.

Additionally or alternatively, from the viewpoint of more effectively obtaining the durability from low temperatures to ordinary temperatures, the breaking elongation of the pressure sensitive adhesive constituting the pressure sensitive adhesive layer in the present embodiment may be preferably 750% or more, particularly preferably 800% or more, and further preferably 850% or more. Although the upper limit of the breaking elongation is not particularly limited, it may be preferably 10,000% or less, particularly preferably 6,000% or less, and further preferably 2,000% or less.

Additionally or alternatively, from the viewpoint of high-temperature durability, the breaking stress of the pressure sensitive adhesive constituting the pressure sensitive adhesive layer in the present embodiment may be preferably 0.20 N/mm² or more, particularly preferably 0.22 N/mm² or more, and further preferably 0.55 N/mm² or more. Although the upper limit of the breaking stress is not particularly limited, it may be preferably 5.00 N/mm² or less, particularly preferably 2.00 N/mm² or less, and further preferably 1.00 N/mm² or less.

In the pressure sensitive adhesive sheet according to the present embodiment, the 500% modulus of the pressure sensitive adhesive constituting the pressure sensitive adhesive layer may be preferably 0.008 N/mm² or more, particularly preferably 0.010 N/mm² or more, and further preferably 0.020 N/mm² or more. From another aspect, the 500% modulus may be preferably 0.30 N/mm² or less, particularly preferably 0.27 N/mm² or less, and further preferably 0.22 N/mm² or less. When the 500% modulus of the pressure sensitive adhesive falls within the above range, the above-described 100% modulus, breaking elongation, and breaking stress can be readily satisfied.

Additionally or alternatively, in the pressure sensitive adhesive sheet according to the present embodiment, the 1000% modulus of the pressure sensitive adhesive constituting the pressure sensitive adhesive layer may be preferably 0.10 N/mm² or more, particularly preferably 0.15 N/mm² or more, and further preferably 0.20 N/mm² or more. From another aspect, the 1000% modulus may be preferably 1.00 N/mm² or less, particularly preferably 0.80 N/mm² or less, and further preferably 0.60 N/mm² or less. When the 1000% modulus of the pressure sensitive adhesive falls within the above range, the above-described 100% modulus, breaking elongation, and breaking stress can be readily satisfied.

Additionally or alternatively, the storage elastic modulus G′ at −20° C. of the pressure sensitive adhesive constituting the pressure sensitive adhesive layer in the present embodiment may be preferably 0.01 MPa or more, particularly preferably 0.04 MPa or more, and further preferably 0.06 MPa or more. From another aspect, the storage elastic modulus G′ may be preferably 1.0 MPa or less, particularly preferably 0.3 MPa or less, further preferably 0.15 MPa or less, and most preferably 0.11 MPa or less. When the storage elastic modulus G′ at −20° C. falls within the above range, the durability from low temperatures to ordinary temperatures can be more excellent.

Additionally or alternatively, the storage elastic modulus G′ at 23° C. of the pressure sensitive adhesive constituting the pressure sensitive adhesive layer in the present embodiment may be preferably 0.001 MPa or more, particularly preferably 0.01 MPa or more, and further preferably 0.03 MPa or more. From another aspect, the storage elastic modulus G′ may be preferably 0.20 MPa or less, particularly preferably 0.10 MPa or less, and further preferably 0.08 MPa or less. When the storage elastic modulus G′ at 23° C. falls within the above range, the above-described 100% modulus, breaking elongation, and breaking stress can be readily satisfied, and both the handling properties and the bending resistance at ordinary temperatures can be readily well achieved.

Details of the measurement methods for the above-described moduli, breaking elongation, breaking stress, and storage elastic modulus G′ are as described in respective Testing Examples, which will be described later.

FIG. 1 illustrates a specific configuration as an example of the pressure sensitive adhesive sheet according to the present embodiment. As illustrated in FIG. 1, a pressure sensitive adhesive sheet 1 according to an embodiment is composed of two release sheets 12a and 12b and a pressure sensitive adhesive layer 11 interposed between the two release sheets 12a and 12b so as to be in contact with release surfaces of the two release sheets 12a and 12b.

### 1. Constitutional Elements

### 1-1. Pressure Sensitive Adhesive Layer

The pressure sensitive adhesive layer 11 is not particularly limited, provided that it is composed of a pressure sensitive adhesive that exhibits the aforementioned 100% modulus, breaking elongation, and breaking stress. The same pressure sensitive adhesive as that in the second embodiment can be used as an example of the pressure sensitive adhesive. In particular, as in the second embodiment, the pressure sensitive adhesive according to the third embodiment may be preferably one obtained by crosslinking a pressure sensitive adhesive composition that contains a (meth)acrylic ester polymer (A), a plasticizer (B), and a crosslinker (C) and optionally a silane coupling agent (D) (such a pressure sensitive adhesive composition may be referred to as a “pressure sensitive adhesive composition P,” hereinafter).

### (1) Components of Pressure Sensitive Adhesive Composition P

### (1-1) (Meth)Acrylic Ester Polymer (A)

The (meth)acrylic ester polymer (A) in the present embodiment may preferably contain, as a monomer unit that constitutes the polymer, a reactive group-containing monomer having in the molecule a reactive group that reacts with the crosslinker (C). The reactive group derived from the reactive group-containing monomer reacts with the crosslinker (C) to form a crosslinked structure (three-dimensional network structure), and the pressure sensitive adhesive to be obtained can readily satisfy the aforementioned 100% modulus, breaking elongation, and breaking stress.

Examples of the above reactive group-containing monomer include the same ones as described in the invention according to the first embodiment. In particular, preferred examples of hydroxyl group-containing monomers, carboxy group-containing monomers, and amino group-containing monomers are the same as those in the invention according to the first embodiment.

The preferred content of the reactive group-containing monomer as a monomer unit that constitutes the polymer in the (meth)acrylic ester polymer (A) may be the same as that in the second embodiment. In the third embodiment, however, from the viewpoint of readily satisfying the aforementioned 100% modulus, breaking elongation, and breaking stress, the content may preferably fall within the aforementioned range.

As in the invention according to the first embodiment, the (meth)acrylic ester polymer (A) in the third embodiment may preferably contain (meth)acrylic alkyl ester as a monomer unit that constitutes the polymer. The specific examples may also be the same as those in the invention according to the first embodiment. In the third embodiment, however, from the viewpoint of further improving the pressure sensitive adhesive properties, (meth)acrylic ester whose carbon number of alkyl group is 4 to 10 may be preferred. Considering the viewpoints that the 100% modulus can be reduced and the storage elastic modulus at low temperatures can be readily set to a lower value, (meth)acrylic ester whose carbon number of alkyl group is 6 to 8 may be further preferred. For example, 2-ethylhexyl (meth)acrylate or isooctyl (meth)acrylate may be preferred. These may each be used alone, or two or more types may also be used in combination.

In the third embodiment, the preferred content of the (meth)acrylic alkyl ester as a monomer unit that constitutes the polymer in the (meth)acrylic ester polymer (A) may be the same as that in the second embodiment. In the third embodiment, however, from the viewpoints that the 100% modulus of the obtained pressure sensitive adhesive can be readily reduced and the pressure sensitive adhesive can be readily obtained with a lower storage elastic modulus at low temperatures and excellent pressure sensitive adhesive properties, the upper limit of the content may preferably fall within the aforementioned range.

If desired, as in the invention according to the first embodiment, the (meth)acrylic ester polymer (A) in the third embodiment may contain other monomers as monomer units that constitute the polymer. The specific examples may also be the same as those in the invention according to the first embodiment.

The (meth)acrylic ester polymer (A) may be preferably a linear polymer. Such a linear polymer may promote the entanglement of molecular chains, and improvement in the cohesive force can be expected, so the pressure sensitive adhesive can be readily obtained with a low 100% modulus and a large breaking elongation.

The (meth)acrylic ester polymer (A) may be preferably a solution polymerization product obtained by a solution polymerization method. Being a solution polymerization product allows a high molecular-weight polymer to be readily obtained, and improvement in the cohesive force can be expected, so the pressure sensitive adhesive can be readily obtained with a low 100% modulus and a large breaking elongation.

The polymerization form of the (meth)acrylic ester polymer (A) may be a random copolymer or may also be a block copolymer.

In the third embodiment, the preferred range of the weight-average molecular weight of the (meth)acrylic ester polymer (A) may be the same as that in the second embodiment.

In the pressure sensitive adhesive composition P, one type of the (meth)acrylic ester polymer (A) may be used alone or two or more types may also be used in combination.

### (1-2) Plasticizer (B)

The plasticizer (B) in the present embodiment is not particularly limited, provided that it can impart plasticity to the pressure sensitive adhesive. For example, the plasticizer (B) in the present embodiment may be preferably a modified cyclodextrin.

Preferred aspects of the modified cyclodextrin in the third embodiment may be the same as those in the second embodiment.

The molecular weight of the plasticizer (B) may be preferably 1,500 or more, particularly preferably 1,600 or more, and further preferably 1,700 or more from the viewpoint of suppressing bleeding out of the plasticizer (B) from the pressure sensitive adhesive thereby to readily suppress a decrease in the adhesive strength. On the other hand, from the viewpoint of the solubility in the pressure sensitive adhesive resin, the molecular weight of the plasticizer (B) may be preferably 50,000 or less, particularly preferably 10,000 or less, and further preferably 5,000 or less.

In the pressure sensitive adhesive composition P, one type of the plasticizer (B) may be used alone or two or more types may also be used in combination.

The content of the plasticizer (B) in the pressure sensitive adhesive composition P may be preferably 0.1 mass parts or more, more preferably 1 mass part or more, particularly preferably 2 mass parts or more, and further preferably 5 mass parts or more with respect to 100 mass parts of the (meth)acrylic ester polymer (A) from the viewpoint of suppressing the 100% modulus to a low value while maintaining a high breaking stress. On the other hand, from the viewpoint of suppressing a decrease in the gel fraction and maintaining a high breaking stress, the content of the plasticizer (B) in the pressure sensitive adhesive composition P may be preferably 50 mass parts or less, particularly preferably 30 mass parts or less, and further preferably 15 mass parts or less with respect to 100 mass parts of the (meth)acrylic ester polymer (A). Considering the viewpoint of further improving the high-temperature durability, the content of the plasticizer (B) in the pressure sensitive adhesive composition P may be most preferably 8 mass parts or less with respect to 100 mass parts of the (meth)acrylic ester polymer (A).

### (1-3) Crosslinker (C)

Preferred examples of the crosslinker (C) in the third embodiment may be the same as those in the first embodiment. In the third embodiment, however, the content of the crosslinker (C) in the pressure sensitive adhesive composition P may be preferably 0.001 mass parts or more, particularly preferably 0.01 mass parts or more, and further preferably 0.1 mass parts or more with respect to 100 mass parts of the (meth)acrylic ester polymer (A). From another aspect, the content of the crosslinker (C) may be preferably mass parts or less, particularly preferably 5 mass parts or less, and further preferably 1 mass part or less. When the content of the crosslinker (B) falls within the above range, the desired adhesive strength and the aforementioned storage elastic modulus G′ can be readily achieved.

### (1-4) Silane Coupling Agent (D)

Preferred examples of the silane coupling agent (D) in the third embodiment may be the same as those in the first embodiment. The content of the silane coupling agent (D) may also be the same as that in the first embodiment.

### (1-5) Various Additives

Also in the third embodiment, the pressure sensitive adhesive composition P may contain additives as in the first embodiment.

### (2) Production of Pressure Sensitive Adhesive Composition P

The pressure sensitive adhesive composition P according to the third embodiment can be prepared in the same manner as in the second embodiment.

### (3) Production of Pressure Sensitive Adhesive

The method of obtaining the pressure sensitive adhesive from the above pressure sensitive adhesive composition P may be the same as that in the first embodiment.

### (4) Physical Properties of Pressure Sensitive Adhesive Layer

The gel fraction of the pressure sensitive adhesive constituting the pressure sensitive adhesive layer 11 in the present embodiment may be preferably 10% or more, more preferably 30% or more, particularly preferably 50% or more, further preferably 60% or more, and most preferably 84% or more. When the above gel fraction is 10% or more, the pressure sensitive adhesive in the present embodiment has a high cohesive force and can readily be excellent in the high-temperature durability. The upper limit of the gel fraction of the pressure sensitive adhesive according to the present embodiment is not particularly limited, and may be, for example, 100% or less in an embodiment, 95% or less in another embodiment, or 90% or less in still another embodiment. Details of the measurement method for the above gel fraction are as described in the Testing Example, which will be described later.

The thickness of the pressure sensitive adhesive layer 11 in the present embodiment may be preferably 2 μm or more, more preferably 5 μm or more, particularly preferably 10 μm or more, further preferably 15 μm or more, and most preferably 20 μm or more as the lower limit. This allows the pressure sensitive adhesive layer 11 to exhibit a desired adhesive strength.

On the other hand, the upper limit of the thickness of the pressure sensitive adhesive layer 11 may be preferably 1,000 μm or less, more preferably 100 μm or less, particularly preferably 60 μm or less, further preferably 40 μm or less, and most preferably 30 μm or less. This allows the pressure sensitive adhesive layer 11 to achieve excellent durability against repeated bending.

### 1-2. Release Sheets

The same release sheets as those in the first embodiment can be used in the second embodiment.

### 2. Physical Properties

### (1) Haze Value

The preferred range of the haze value (normal haze value) of the pressure sensitive adhesive layer 11 in the third embodiment may be the same as that in the second embodiment.

Additionally or alternatively, the haze value of the pressure sensitive adhesive layer 11 in the present embodiment after leaving it untouched under an environment of −40° C. for 72 hours (haze value after 72 hours at −40° C.) may be preferably 20% or less, more preferably 10% or less, particularly preferably 6% or less, and further preferably 4% or less. This allows the pressure sensitive adhesive layer 11 in the present embodiment to exhibit good light transmittance even when placed under low-temperature conditions, and the repetitive bending device configured using the pressure sensitive adhesive layer 11 can readily exhibit the desired performance. On the other hand, the lower limit of the above haze value (haze value after 72 hours at −40° C.) of the pressure sensitive adhesive layer 11 is not particularly limited, and may be, for example, 0.1% or more in an embodiment or 0.4% or more in another embodiment. Details of the measurement method for the above haze value (haze value after 72 hours at −40° C.) are as described in the Testing Example, which will be described later.

### (2) Total Luminous Transmittance

The preferred range of the total luminous transmittance of the pressure sensitive adhesive layer 11 in the third embodiment may be the same as that in the second embodiment.

### (3) Adhesive Strength

The preferred range of the adhesive strength of the pressure sensitive adhesive sheet 1 to a non-alkali glass plate at 23° C. in the third embodiment may be the same as that in the second embodiment.

### 3. Production of Pressure Sensitive Adhesive Sheet

The pressure sensitive adhesive sheet in the third embodiment can be produced in the same manner as in the first embodiment.

### <Repetitive Bending Laminate Member>

The preferred aspects of the repetitive bending laminate member according to the third embodiment are the same as those in the second embodiment.

### <Repetitive Bending Device>

The preferred aspects of the repetitive bending device according to the third embodiment are the same as those in the second embodiment.

The aforementioned embodiments are described to facilitate understanding of the present invention and are not described to limit the present invention. It is therefore intended that the elements disclosed in the above embodiments include all design changes and equivalents to fall within the technical scope of the present invention.

For example, one or both of the release sheets 12a and 12b in the pressure sensitive adhesive sheet 1 may be omitted, and one or more desired bendable members may be laminated as substitute for the release sheets 12a and/or 12b.

### EXAMPLES

Hereinafter, the present invention will be described further specifically with reference to examples, etc., but the scope of the present invention is not limited to these examples, etc.

### Examples According to First Embodiment

### Preparation Example 1-1

To 8.5 ml of isopropenyl acetate as a solvent, 1.8 g of β-cyclodextrin (available from NACALAI TESQUE, INC.) and 47 mg of p-toluenesulfonic acid monohydrate as a catalyst were added and reacted at 70° C. for 16 hours. After the reaction solution was distilled under reduced pressure and the obtained solid was washed with a 10 mass % of sodium carbonate aqueous solution, 2.5 g of acetylated β-cyclodextrin was obtained as a white solid through extraction with chloroform and recrystallization with acetone.

A portion of the obtained acetylated β-cyclodextrin was dissolved in deuterated chloroform and analyzed with ¹H-NMR (available from JEOL Ltd., product name “Nuclear Magnetic Resonance Apparatus JNM-LA400/WB”). As a result of the analysis, the degree of modification was calculated as 2.98 from the integral ratio of the peak derived from the proton attached to the first carbon of the glucose ring near 5.1 ppm and the peak derived from the acetyl group near 2.1 ppm in the ¹H-NMR chart.

### Preparation Example 1-2

To 8.5 ml of isopropenyl acetate as a solvent, 2 g of γ-cyclodextrin (available from NACALAI TESQUE, INC.) and 47 mg of p-toluenesulfonic acid monohydrate as a catalyst were added and reacted at 70° C. for 16 hours. After the reaction solution was distilled under reduced pressure and the obtained solid was washed with a 10 mass % of sodium carbonate aqueous solution, 2.5 g of acetylated γ-cyclodextrin was obtained as a white solid through extraction with chloroform and recrystallization with acetone.

A portion of the obtained acetylated γ-cyclodextrin was dissolved in deuterated chloroform and analyzed with ¹H-NMR (available from JEOL Ltd., product name “Nuclear Magnetic Resonance Apparatus JNM-LA400/WB”). As a result of the analysis, the degree of modification was calculated as 2.97 from the integral ratio of the peak derived from the proton attached to the first carbon of the glucose ring near 5.1 ppm and the peak derived from the acetyl group near 2.1 ppm in the ¹H-NMR chart.

### Example 1-1

### 1. Preparation of (Meth)Acrylic Ester Polymer

The (meth)acrylic ester polymer (A) was prepared by using a solution polymerization method to copolymerize 95 mass parts of n-butyl acrylate, 4 mass parts of acrylic acid, and 1 part by mass of 2-hydroxyethyl acrylate. The molecular weight of the (meth)acrylic ester polymer (A) was measured by the method to be described later. The weight-average molecular weight (Mw) was 2,000,000.

### 2. Preparation of Pressure Sensitive Adhesive Composition

Coating solution of the pressure sensitive adhesive composition P was obtained through mixing and sufficiently stirring 100 mass parts (solid content equivalent, here and hereinafter) of the (meth)acrylic ester polymer (A) obtained in the above step 1, 18.0 mass parts of acetylated γ-cyclodextrin (degree of modification: 2.97) prepared as the modified cyclodextrin (B) in Preparation Example 1-1, 0.27 mass parts of trimethylol propane-modified tolylene diisocyanate (isocyanate-based crosslinker, available from TOYOCHEM CO., LTD., product name “BHS8515”) as the crosslinker (C), 0.02 mass parts of an epoxy-based crosslinker (available from TOYO INK CO., LTD., product name “BXX5983TF”) as the crosslinker (C), and 0.10 mass parts of 3-glycidoxypropyltrimethoxysilane as the silane coupling agent (D) and diluting the mixture with methyl ethyl ketone.

### 3. Formation of Pressure Sensitive Adhesive Layer

The release-treated surface of a tight release sheet (available from LINTEC Corporation, product name “SP-PET752150”) was coated with the coating solution of the pressure sensitive adhesive composition P obtained in the above step 2 by using a knife coater, and heat treatment was performed at 90° C. for 1 minute to form the pressure sensitive adhesive layer having a thickness of 5 μm. In the tight release sheet, one surface of a polyethylene terephthalate film was subjected to release treatment with a silicone-based release agent. Subsequently, the release-treated surface of an easy release sheet (available from LINTEC Corporation, product name “SP-PET381130”) obtained by release-treating one surface of a polyethylene terephthalate film with a silicone-based release agent was bonded to the surface of the pressure sensitive adhesive layer opposite to the tight release sheet. The pressure sensitive adhesive sheet was thus produced, having a configuration of tight release sheet/pressure sensitive adhesive layer (thickness: 5 μm)/easy release sheet.

Here, the aforementioned weight-average molecular weight (Mw) refers to a weight-average molecular weight that is measured as a standard polystyrene equivalent value under the following condition using gel permeation chromatography (GPC) (GPC measurement).

### «Measurement Condition»

Measurement device: HLC-8320 available from Tosoh Corporation
GPC columns (passing through in the following order): available from Tosoh Corporation
   TSK gel super H-H
   TSK gel super HM-H
   TSK gel super H2000
Solvent for measurement: tetrahydrofuran
Measurement temperature: 40° C.

The thickness of the above pressure sensitive adhesive layer is a value measured according to JIS K7130 using a constant-pressure thickness meter (available from TECLOCK Co., Ltd., product name “PG-02”).

### Examples 1-2 to 1-4 and Comparative Examples 1-1 to 1-4

Pressure sensitive adhesive sheets were produced in the same manner as in Example 1-1 except that the composition and weight-average molecular weight of the (meth)acrylic ester polymer (A), the type and compounding amount of the modified cyclodextrin (B), the type and compounding amount of the crosslinker (C), and the compounding amount of the silane coupling agent (D) were as listed in Table 1.

### <Testing Example 1-1> (Measurement of Gel Fraction)

The pressure sensitive adhesive sheet produced in each of Examples and Comparative Examples was cut into a size of 80 mm×80 mm, the pressure sensitive adhesive layer was wrapped in a polyester mesh (mesh size of 200), the mass was weighed with a precision balance, and the mass of the pressure sensitive adhesive alone was calculated by subtracting the mass of the above mesh itself. The mass at that time is M1.

Then, the pressure sensitive adhesive wrapped in the above polyester mesh was immersed in ethyl acetate at room temperature (23° C.) for 24 hours. After that, the pressure sensitive adhesive was taken out, air-dried under an environment of a temperature of 23° C. and a relative humidity of 50% for 24 hours, and further dried in an oven at 80° C. for 12 hours. After the drying, the mass was weighed with a precision balance, and the mass of the pressure sensitive adhesive alone was calculated by subtracting the mass of the mesh itself. The mass at that time is M2. The gel fraction (%) of the pressure sensitive adhesive was calculated by (M2/M1)×100. The results are listed in Table 2.

### <Testing Example 1-2> (Measurement of Adhesive Strength)

The easy release sheet was removed from the pressure sensitive adhesive sheet obtained in each of Examples and Comparative Examples, and the exposed pressure sensitive adhesive layer was bonded to the easy-adhesion layer of a polyethylene terephthalate (PET) film having the easy-adhesion layer (available from TOYOBO CO., LTD., product name “PET A4300,” thickness: 100 μm) to obtain a laminate of tight release sheet/pressure sensitive adhesive layer/PET film. The obtained laminate was cut into a width of 25 mm and a length of 100 mm, and this was used as a sample.

The tight release sheet was removed from the above sample under an environment of 23° C. and 50% RH, and the exposed pressure sensitive adhesive layer was bonded to a non-alkali plate (available from Corning, product name “Eagle XG”) and then pressurized in an autoclave available from KURIHARA SEISAKUSHO Co., Ltd. at 0.5 MPa and 50° C. for 20 minutes. After that, the sample was left untouched under a condition of 23° C. and 50% RH for 24 hours. Then, the adhesive strength (N/25 mm) was measured under an environment of 23° C. and 50% RH with a condition of a peel speed of 300 mm/min and a peel angle of 180° using a tensile tester (available from ORIENTEC Co., LTD., product name “TENSILON”). The measurement was conducted according to JIS 20237: 2009 except for the condition described herein. The results are listed in Table 2 each as the adhesive strength against the non-alkali glass plate (measurement temperature: 23° C.)

In addition, a soda lime glass plate (available from Nippon Sheet Glass Company, Ltd., product name “Soda Lime Glass”) was used as the object to which the above sample was bonded, rather than the non-alkali glass plate, and the adhesive strength (N/25 mm) was measured in the same manner as above except that the temperature condition when peeling off the sample using the tensile tester was 0° C., 23° C., or 50° C. The results are also listed in Table 2 each as the adhesive strength against the soda lime glass plate (measurement temperature: 0° C., 23° C., or 50° C.).

### <Testing Example 1-3> (Measurement of Haze Value and Total Luminous Transmittance)

For the pressure sensitive adhesive layer of the pressure sensitive adhesive sheet obtained in each of Examples and Comparative Examples, the haze value (%) and the total luminous transmittance (%) were measured using a haze meter (available from NIPPON DENSHOKU INDUSTRIES CO., LTD., product name “NDH5000”). The results are listed in Table 2.

### <Testing Example 1-4> (Measurement of 1000% Modulus)

After laminating a plurality of pressure sensitive adhesive layers of the pressure sensitive adhesive sheet obtained in each of Examples and Comparative Examples to a total thickness of 600 μm, a sample of 10 mm width×75 mm length was cut out. The above sample was set in a tensile tester (available from Shimadzu Corporation, product name “Autograph”) so as to have a sample measurement site of 10 mm width×20 mm length (extension direction) and extended at a tensile speed of 200 mm/min under an environment of 23° C. and 50% RH using the tensile tester, and the stress value at which the elongation ratio was 1,000% was measured as the 1000% modulus (N/mm²). The results are listed in Table 2.

### <Testing Example 1-5> (Evaluation of High-temperature Durability)

The easy release sheet was removed from the pressure sensitive adhesive sheet obtained in each of Examples and Comparative Examples, and the exposed pressure sensitive adhesive layer was bonded to a polyethylene terephthalate (PET) film (available from Toray Industries, Inc., product name “Lumirror #38-U48,” thickness: 38 μm). After that, it was cut into a size of length 30.5 cm×width 22.5 cm.

Subsequently, the tight release sheet was removed from the above laminate, the exposed pressure sensitive adhesive layer was bonded to non-alkali glass (available from Corning, product name “Eagle XG”) and then pressurized in an autoclave available from KURIHARA SEISAKUSHO Co., Ltd. at 0.5 MPa and 50° C. for 20 minutes, and this was used as an evaluation sample.

After the above evaluation sample was subjected to a durability condition of 80° C., Dry (no humidity control), and 500 hours, the presence or absence of floating, delamination, and foaming at an end portion of the evaluation sample in the long axis direction was confirmed using a digital optical microscope. Then, the high-temperature durability was evaluated according to the following evaluation criteria. The results are listed in Table 2.
A: No floating, delamination, or foaming was observed.
B: Floating, delamination, and foaming were confirmed at the end portion, but their maximum size was less than 1 mm.
C: Floating, delamination, and foaming were confirmed at the end portion, but their maximum size was less than 5 mm.
D: Floating, delamination, and foaming exceeding 5 mm were confirmed at the end portion.

Furthermore, a cycloolefin polymer (COP) film (available from Zeon Corporation, product name “Zeonor Film ZF-16,” thickness: 100 μm) was used as the object to which the pressure sensitive adhesive layer was bonded, rather than the above PET film, and the high-temperature durability was evaluated in the same manner as above. The results are also listed in Table 2. Just for information, the above COP film has a characteristic that the contraction when placed under a high-temperature environment is lower than that of the PET film.

Details of the simplified names listed in Table 1 and additional information are as follows.

### [(Meth) Acrylic Ester Polymer (A)]

BA: n-butyl acrylate
AA: acrylic acid
HEA: 2-hydroxyethyl acrylate
4HBA: 4-hydroxybutyl acrylate

### [Modified Cyclodextrin (B)]

AcβCD: acetylated β-cyclodextrin prepared in Preparation Example 1-1 (degree of modification: 2.98)
AcγCD: acetylated γ-cyclodextrin prepared in Preparation Example 1-2 (degree of modification: 2.97)

TABLE 1

| | Composition of pressure sensitive adhesive composition P (mass parts) | | | | | | | | | | |
|---|---|---|---|---|---|---|---|---|---|---|---|
| | (Meth)acrylic ester polymer (A) | | | | | | | | | | Silane |
| | | | | | Weight- | | Modified | | Crosslinker (C) | | coupling |
| | | | | | average | | cyclodextrin (B) | | Isocyanate- | Epoxy- | agent |
| | BA | AA | HEA | 4HBA | molecular | | Ac β CD | Ac γ CD | based | based | (D) |
| Example 1-1 | 95 | 4 | 1 | — | 2 | mil. | — | 18.0 | 0.27 | 0.02 | 0.10 |
| Example 1-2 | 99 | — | — | 1 | 1 | mil. | — | 9.0 | 0.35 | — | 0.10 |
| Example 1-3 | 99 | — | — | 1 | 1 | mil. | — | 4.5 | 0.35 | — | — |
| Example 1-4 | 95 | 4 | 1 | — | 2 | mil. | 15.7 | — | 0.27 | 0.02 | 0.10 |
| Comparative | 95 | 4 | 1 | — | 2 | mil. | — | — | 0.27 | 0.02 | 0.10 |
| Example 1-1 | | | | | | | | | | | |
| Comparative | 99 | — | — | 1 | 1.2 | mil. | — | — | — | — | 0.10 |
| Example 1-2 | | | | | | | | | | | |
| Comparative | 95 | 4 | 1 | — | 2 | mil. | — | 18.0 | — | — | 0.10 |
| Example 1-3 | | | | | | | | | | | |
| Comparative | 95 | 4 | 1 | — | 2 | mil. | — | 54.0 | — | — | 0.10 |
| Example 1-4 | | | | | | | | | | | |

TABLE 2

| | | Adhesive strength (N/25 mm) | | | | | | | | |
|---|---|---|---|---|---|---|---|---|---|---|
| | | Against | | | | | Total | | [symbol] aluation of high | |
| | Gel | non-alkali | | | | Haze | luminous | 1000% | temperature durabi [symbol] | |
| | fraction | glass | Against soda lime glass | | | value | transmittance | modulus | PET | COP film (low |
| | (%) | 23° C. | 0° C. | 23° C. | 50° C. | (%) | (%) | (N/mm²) | film | contractible) |
| Example 1-1 | 65.9 | 10.8 | 12.0 | 10.3 | 10.4 | 0.8 | 91.8 | 0.399 | A | A |
| Example 1-2 | 68.2 | 11.2 | 16.5 | 10.6 | 12.2 | 0.6 | 91.8 | 0.332 | B | A |
| Example 1-3 | 73.0 | 10.0 | 16.8 | 11.2 | 14.8 | 0.6 | 91.9 | 0.306 | B | B |
| Example 1-4 | 77.4 | 9.3 | 11.8 | 10.3 | 8.6 | 1.1 | 91.8 | 0.729 | A | A |
| Comparative | 84.8 | 9.5 | 17.9 | 12.0 | 15.0 | 0.6 | 91.9 | 0.242 | C | A |
| Example 1-1 | | | | | | | | | | |
| Comparative | 1.2 | 11.4 | 15.8 | 8.0 | 25.0 | 0.8 | 91.9 | 0.121 | C | D |
| Example 1-2 | | | | | | | | | | |
| Comparative | 0.7 | 10.7 | 10.9 | 12.5 | 9.3 | 1.0 | 91.8 | 0.097 | D | D |
| Example 1-3 | | | | | | | | | | |
| Comparative | 0.7 | 8.5 | 9.1 | 9.0 | 7.5 | 1.3 | 91.8 | 0.092 | D | D |
| Example 1-4 | | | | | | | | | | |

[symbol]

indicates data missing or illegible when filed

As found from Table 2, the pressure sensitive adhesive sheets produced in Examples exhibited excellent high-temperature durability as compared to the pressure sensitive adhesive sheets produced in Comparative Examples. Moreover, the pressure sensitive adhesive sheets produced in Examples exhibited good adhesive strength and good optical properties (haze value and total luminous transmittance).

### Examples According to Second Embodiment

### Preparation Example 2-1

To 5 ml of isopropenyl acetate as a solvent, 0.5 g of β-cyclodextrin (available from NACALAI TESQUE, INC.) and 20 mg of p-toluenesulfonic acid as a catalyst were added and reacted at 70° C. for 2 hours. After the reaction solution was distilled under reduced pressure and the obtained solid was washed with a 10 mass % of sodium carbonate aqueous solution, 0.8 g of acetylated β-cyclodextrin was obtained as a white solid through recrystallization with acetone.

A portion of the obtained acetylated β-cyclodextrin was dissolved in deuterated chloroform and analyzed with ¹H-NMR (available from JEOL Ltd., product name “Nuclear Magnetic Resonance Apparatus JNM-LA400/WB”). As a result of the analysis, the degree of modification was calculated as 2.98 from the integral ratio of the peak derived from the proton attached to the first carbon of the glucose ring near 5.1 ppm and the peak derived from the acetyl group near 2.1 ppm in the ¹H-NMR chart.

### Preparation Example 2-2

To 5 ml of isopropenyl acetate as a solvent, 0.5 g of γ-cyclodextrin (available from NACALAI TESQUE, INC.) and 20 mg of p-toluenesulfonic acid as a catalyst were added and reacted at 70° C. for 2 hours. After the reaction solution was distilled under reduced pressure and the obtained solid was washed with a 10 mass % of sodium carbonate aqueous solution, 0.8 g of acetylated γ-cyclodextrin was obtained as a white solid through recrystallization with acetone.

A portion of the obtained acetylated γ-cyclodextrin was dissolved in deuterated chloroform and analyzed with ¹H-NMR (available from JEOL Ltd., product name “Nuclear Magnetic Resonance Apparatus JNM-LA400/WB”). As a result of the analysis, the degree of modification was calculated as 2.97 from the integral ratio of the peak derived from the proton attached to the first carbon of the glucose ring near 5.1 ppm and the peak derived from the acetyl group near 2.1 ppm in the ¹H-NMR chart.

### Example 2-1

### 1. Preparation of (Meth)Acrylic Ester Polymer (A)

The (meth)acrylic ester polymer (A) was prepared by using a solution polymerization method to copolymerize 98 mass parts of 2-ethylhexyl acrylate, 1.5 mass parts of 4-hydroxybutyl acrylate, and 0.5 mass parts of acrylic acid. When the molecular weight of the (meth)acrylic ester polymer (A) was measured by the aforementioned method, the weight-average molecular weight (Mw) was 1,200,000.

### 2. Preparation of Pressure Sensitive Adhesive Composition

Coating solution of the pressure sensitive adhesive composition P was obtained through mixing and sufficiently stirring 100 mass parts (solid content equivalent, here and hereinafter) of the (meth)acrylic ester polymer (A) obtained in the above step 1, 10 mass parts of acetyl tributyl citrate (ATBC) as the plasticizer (B), 0.75 mass parts of trimethylolpropane-modified xylylene diisocyanate (available from Soken Chemical & Engineering Co., Ltd., product name “TD-75”) as the crosslinker (C), and 0.25 mass parts of 3-glycidoxypropyltrimethoxysilane as the silane coupling agent (D) and diluting the mixture with methyl ethyl ketone.

### 3. Production of Pressure Sensitive Adhesive Sheet

The release-treated surface of a tight release sheet (available from LINTEC Corporation, product name “SP-PET752150”) was coated with the coating solution of the pressure sensitive adhesive composition P obtained in the above step 2 by using a knife coater, and heat treatment was performed at 90° C. for 1 minute to form the pressure sensitive adhesive layer having a thickness of 25 μm. In the tight release sheet, one surface of a polyethylene terephthalate film was subjected to release treatment with a silicone-based release agent. Subsequently, the release-treated surface of an easy release sheet (available from LINTEC Corporation, product name “SP-PET381130”) obtained by release-treating one surface of a polyethylene terephthalate film with a silicone-based release agent was bonded to the surface of the pressure sensitive adhesive layer opposite to the tight release sheet. The pressure sensitive adhesive sheet was thus produced, having a configuration of tight release sheet/pressure sensitive adhesive layer (thickness: 25 μm)/easy release sheet. The thickness of the above pressure sensitive adhesive layer was measured in the same manner as in the first embodiment.

### Examples 2-2 and 2-3 and Comparative Examples 2-1 and 2-2

Pressure sensitive adhesive sheets were produced in the same manner as in Example 2-1 except that the composition of the (meth)acrylic ester polymer (A), the type of the plasticizer (B), and the content of the crosslinker (C) were as listed in Table 3.

### <Testing Example 2-1> (Measurement of Gel Fraction)

The gel fraction (%) of the pressure sensitive adhesive according to each of Examples and Comparative Examples was calculated in the same manner as in Testing Example 1-1. The results are listed in Table 4.

### <Testing Example 2-2> (Measurement of Adhesive Strength)

For the pressure sensitive adhesive sheet obtained in each of Examples and Comparative Examples, the adhesive strength (N/25 mm) against a non-alkali glass plate was measured in the same manner as in the measurement method for the adhesive strength against the non-alkali glass plate (measurement temperature: 23° C.) in Testing Example 1-2. The results are listed in Table 4.

### <Testing Example 2-3> (Measurement of Storage Elastic Modulus G′)

A laminate having a thickness of 3 mm was obtained by laminating a plurality of pressure sensitive adhesive layers of the pressure sensitive adhesive sheet produced in each of Examples and Comparative Examples. A cylindrical body (height of 3 mm) having a diameter of 8 mm was punched out from the obtained laminate of the pressure sensitive adhesive layers, and this was used as a sample.

For the above sample, the storage elastic modulus G′ was measured by a torsional shear method according to JIS K7244-1 using a viscoelasticity measurement device (available from Anton Paar, product name “MCR302”) under the following condition, and the storage elastic modulus (G′) (MPa) was acquired at each of −25° C., 0° C., 23° C., and 40° C. The results are listed in Table 4.
Measurement frequency: 1 Hz
Measurement temperature range: −25° C. to 150° C.

### <Testing Example 2-4> (Measurement of Haze Value)

The easy release sheet was removed from the pressure sensitive adhesive sheet obtained in each of Examples and Comparative Examples, and the exposed pressure sensitive adhesive layer was bonded to a soda lime glass plate (available from Nippon Sheet Glass Company, Ltd., product name “Soda Lime Glass,” thickness: 1.1 mm) to obtain a laminate having a layer configuration of tight release sheet/pressure sensitive adhesive layer/soda lime glass plate. By further removing the tight release sheet from the laminate, a measurement sample composed of the pressure sensitive adhesive layer and the soda lime glass plate was obtained.

For the measurement sample, the haze value (%) was measured using a haze meter (available from NIPPON DENSHOKU INDUSTRIES CO., LTD., product name “NDH5000”). The results are listed in Table 4 as normal haze values.

In addition, a laminate having the layer configuration of tight release sheet/pressure sensitive adhesive layer/soda lime glass plate obtained in the same manner as above was left untouched under an environment of −20° C. for 72 hours. Subsequently, after the laminate was left untouched under an environment of 23° C. for 2 hours, the tight release sheet was removed to obtain a measurement sample composed of the pressure sensitive adhesive layer and the soda lime glass plate. The haze value (%) of the measurement sample was also measured in the same manner as above. The results are listed in Table 4 as the haze values after 72 hours at −20° C.

Furthermore, the absolute values obtained by subtracting the haze values after 72 hours at −20° C. from the normal haze values obtained as above are listed in Table 4 as Δhaze (points).

### <Testing Example 2-5> (Measurement of Total Luminous Transmittance)

For the pressure sensitive adhesive layer of the pressure sensitive adhesive sheet according to each of Examples and Comparative Examples, the total luminous transmittance (%) was measured in the same manner as in Testing Examples 1-3. The results are listed in Table 4.

### <Testing Example 2-6> (Evaluation of Durability)

One surface of the pressure sensitive adhesive layer of the pressure sensitive adhesive sheet prepared in each of Examples and Comparative Examples was bonded to one surface of a polyethylene terephthalate (PET) film (thickness: 50 μm), and the other surface of the pressure sensitive adhesive layer was bonded to a polyimide film (thickness: 50 μm). A laminate thus obtained of PET film/pressure sensitive adhesive layer/polyimide film was cut into a size of 150 mm×50 mm, and this was used as a test piece.

As illustrated in FIG. 6, both end portions of the obtained test piece were fixed to two holding plates of a bending tester with a constant temperature and humidity chamber (available from YUASA SYSTEM Co., Ltd., product name “CL09-type D01-FSC90”). Then, the test piece was bent 200,000 times under temperature environments of −30° C., 23° C., and 80° C. with a bending diameter (diameter) of 3 mmφ, a stroke of 80 mm, and a bending speed of 60 rpm.

After performing the above bending test, the change in the appearance of the bent portion of the test piece was visually confirmed. The results are listed in Table 4.
A: No change in appearance occurred.
B: There was no occurrence of floating, delamination, or generation of air bubbles, but bent marks remained.
C: There was no occurrence of floating or delamination, but generation of air bubbles occurred.
D: Floating and delamination occurred.

Details of the simplified names listed in Table 3 and additional information are as follows.

### [(Meth) Acrylic Ester Polymer (A)]

2EHA: 2-ethylhexyl acrylate
4HBA: 4-hydroxybutyl acrylate
AA: acrylic acid

### [Plasticizer (B)]

ATBC: acetyl tributyl citrate
AcβCD: acetylated β-cyclodextrin prepared in Preparation Example 1 (degree of modification: 2.98)
AcγCD: acetylated γ-cyclodextrin prepared in Preparation Example 2 (degree of modification: 2.97)

TABLE 3

| | Composition of pressure sensitive adhesive composition P (mass parts) | | | | | | | | |
|---|---|---|---|---|---|---|---|---|---|
| | (Meth)acrylic ester polymer (A) | | | | | | | | |
| | | | | Weight- | | | | | Silane |
| | | | | average | Plasticizer (B) | | | Crosslinker | coupling |
| | 2EHA | 4HBA | AA | molecular | ATBC | Ac β CD | Ac γ CD | (C) | agent (D) |
| Example 2-1 | 98 | 1.5 | 0.5 | 1.2 mil. | 10 | — | — | 0.75 | 0.25 |
| Example 2-2 | 98 | 1.5 | 0.5 | 1.2 mil. | — | — | 10 | 0.75 | 0.25 |
| Example 2-3 | 98 | 1.5 | 0.5 | 1.2 mil. | — | 10 | — | 0.75 | 0.25 |
| Comparative | 98 | 2 | — | 1.2 mil. | — | — | — | 0.75 | 0.25 |
| Example 2-1 | | | | | | | | | |
| Comparative | 98 | 1.5 | 0.5 | 1.2 mil. | — | — | — | 0.30 | 0.25 |
| Example 2-2 | | | | | | | | | |

TABLE 4

| | | | | | | | | | | Total | | | |
|---|---|---|---|---|---|---|---|---|---|---|---|---|---|
| | | | | | | | Haze value (%) | | | luminous | | | |
| | Gel | Adhesive | | | | | | After | | trans- | Evaluation | | |
| | fraction | strength | Storage elastic modulus G′ (Pa [symbol] | | | | | 72 H at | Δ haze | mittance | of durability | | |
| | (%) | (N/25 mm) | −25° C. | 0° C. | 23° C. | 40° C. | Normal | −20° C. | (points) | (%) | −30° C. | 23° C. | 80° C. |
| Example 2-1 | 82.2 | 0.8 | 73200 | 38500 | 27800 | 24200 | 1.8 | 2.0 | −0.2 | 91.3 | B | B | B |
| Example 2-2 | 66.3 | 4.5 | 82600 | 50300 | 32500 | 25400 | 3.2 | 2.9 | 0.3 | 91.9 | A | A | A |
| Example 2-3 | 73.2 | 4.1 | 118000 | 55100 | 34800 | 26800 | 5.6 | 5.6 | 0.0 | 91.9 | B | B | A |
| Comparative | 83.4 | 0.8 | 65700 | 32000 | 21400 | 17300 | 1.1 | 1 | 0.1 | 91.4 | C | C | B |
| Example 2-1 | | | | | | | | | | | | | |
| Comparative | 68.2 | 2.2 | 57900 | 27400 | 17700 | 13900 | 2.9 | 2.8 | 0.1 | 91.3 | D | C | C |
| Example 2-2 | | | | | | | | | | | | | |

[symbol]

indicates data missing or illegible when filed

As found from Table 4, the pressure sensitive adhesive sheets produced in Examples were excellent in the durability at low temperature (−30° C.) and ordinary temperature (23° C.) as compared to the pressure sensitive adhesive sheets produced in Comparative Examples. Moreover, the pressure sensitive adhesive sheets produced in Examples exhibited relatively good durability even at high temperature (80° C.) Furthermore, the pressure sensitive adhesive sheets produced in Examples exhibited good optical properties (haze value and total luminous transmittance).

### Examples According to Third Embodiment

### Preparation Example 3-1

Acetylated β-cyclodextrin was prepared in the same manner as in Preparation Example 2-1. In addition, ¹H-NMR analysis was performed in the same manner as in Preparation Example 2-1, and the degree of modification was confirmed to be 2.98 in the same manner as in Preparation Example 2-1. Furthermore, the molecular weight of the obtained acetylated β-cyclodextrin was found to be 2,016 from the chemical structure estimated from the above analysis.

### Preparation Example 3-2

Acetylated β-cyclodextrin was prepared in the same manner as in Preparation Example 2-2. In addition, 1H-NMR analysis was performed in the same manner as in Preparation Example 2-2, and the degree of modification was confirmed to be 2.97 in the same manner as in Preparation Example 2-2. Furthermore, the molecular weight of the obtained acetylated β-cyclodextrin was found to be 2,305 from the chemical structure estimated from the above analysis.

### Example 3-1

Coating solution of the pressure sensitive adhesive composition P was obtained through mixing and sufficiently stirring 100 mass parts (solid content equivalent, here and hereinafter) of the (meth)acrylic ester polymer (A) prepared in the same manner as in Example 2-1, 10 mass parts of acetyl tributyl citrate (ATBC) as the plasticizer (B), 0.75 mass parts of trimethylolpropane-modified xylylene diisocyanate (available from Soken Chemical & Engineering Co., Ltd., product name “TD-75”) as the crosslinker (C), and 0.25 mass parts of 3-glycidoxypropyltrimethoxysilane as the silane coupling agent (D) and diluting the mixture with methyl ethyl ketone. Using the coating solution, the pressure sensitive adhesive sheet was produced in the same manner as in Example 2-1.

### Examples 3-2 to 3-5 and Comparative Examples 3-1 and 3-2

Pressure sensitive adhesive sheets were produced in the same manner as in Example 3-1 except that the composition of the (meth)acrylic ester polymer (A), the type and content of the plasticizer (B), the content of the crosslinker (C), and the content of the silane coupling agent (D) were as listed in Table 5.

### <Testing Example 3-1> (Measurement of Gel Fraction)

The gel fraction (%) of the pressure sensitive adhesive according to each of Examples and Comparative Examples was calculated in the same manner as in Testing Example 1-1. The results are listed in Table 6.

### <Testing Example 3-2> (Measurement of Adhesive Strength)

For the pressure sensitive adhesive sheet obtained in each of Examples and Comparative Examples, the adhesive strength (N/25 mm) against a non-alkali glass plate was measured in the same manner as in the measurement method for the adhesive strength against the non-alkali glass plate (measurement temperature: 23° C.) in Testing Example 1-2. The results are listed in Table 6.

### <Testing Example 3-3> (Measurement of Storage Elastic Modulus G′)

In the same manner as in Testing Example 2-3, the storage elastic modulus G′ (MPa) of the pressure sensitive adhesive layer of the pressure sensitive adhesive sheet produced in each of Examples and Comparative Examples was acquired. In this testing example, however, the storage elastic modulus G′ (MPa) was acquired at each of −20° C. and 23° C. The results are listed in Table 6.

### <Testing Example 3-4> (Measurement of Moduli, Breaking Stress, and Breaking Elongation)

After laminating a plurality of pressure sensitive adhesive layers of the pressure sensitive adhesive sheet prepared in each of Examples and Comparative Examples to a total thickness of 600 μm, a sample of 10 mm width×70 mm length was cut out. The above sample was set in a tensile tester (available from ORIENTEC Co., LTD., product name “TENSILON”) so as to have a sample measurement site of 10 mm width×20 mm length (extension direction) and extended at a tensile speed of 200 mm/min under an environment of 23° C. and 50% RH using the tensile tester. From the stress-strain curve (SS curve) thus obtained, the stress values (N/mm²) at which the elongation ratios were 100%, 500%, and 1,000% were calculated (measured). These results are listed in Table 6 as moduli of 100%, 500%, and 1,000%.

In the above tensile test, the elongation ratio of the sample when the sample was elongated until it broke was measured as the breaking elongation (%), and the stress value at break was measured as the breaking stress (N/mm²). These results are also listed in Table 6.

### <Testing Example 3-5> (Measurement of Haze Value)

For the pressure sensitive adhesive sheet obtained in each of Examples and Comparative Examples, the normal haze value (%) was measured in the same manner as in Testing Example 2-4. The results are listed in Table 6.

In addition, a laminate having the layer configuration of tight release sheet/pressure sensitive adhesive layer/soda lime glass plate obtained in the same manner as in Testing Example 2-4 was left untouched under an environment of −20° C. for 72 hours. Subsequently, after the laminate was left untouched under an environment of 23° C. for 2 hours, the tight release sheet was removed to obtain a measurement sample composed of the pressure sensitive adhesive layer and the soda lime glass plate. The haze value (%) of the measurement sample was also measured in the same manner as in Testing Example 2-4. The results are listed in Table 6 as the haze values after 72 hours at −20° C.

Furthermore, the absolute values obtained by subtracting the haze values after 72 hours at −20° C. from the normal haze values obtained as above are listed in Table 6 as Δhaze (points).

### <Testing Example 3-6> (Measurement of Total Luminous Transmittance)

For the pressure sensitive adhesive layer of the pressure sensitive adhesive sheet according to each of Examples and Comparative Examples, the total luminous transmittance (%) was measured in the same manner as in Testing Examples 1-3. The results are listed in Table 6.

### <Testing Example 3-7> (Evaluation of Durability)

For the pressure sensitive adhesive sheet according to each of Examples and Comparative Examples, evaluation of the durability was conducted in the same manner as in Testing Examples 2-6. The results are listed in Table 6.

Details of the simplified names listed in Table 5 and additional information are as follows.

### [(Meth) Acrylic Ester Polymer (A)]

2EHA: 2-ethylhexyl acrylate
BA: n-butyl acrylate
4HBA: 4-hydroxybutyl acrylate
AA: acrylic acid

### [Plasticizer (B)]

ATBC: acetyl tributyl citrate (molecular weight: 412)
AcβCD: acetylated β-cyclodextrin prepared in Preparation Example 1 (degree of modification: 2.98, molecular weight: 2,016))
AcγCD: acetylated γ-cyclodextrin prepared in Preparation Example 2 (degree of modification: 2.97, molecular weight: 2,305)

TABLE 5

| | Composition of pressure sensitive adhesive composition P (mass parts) | | | | | | | | | | |
|---|---|---|---|---|---|---|---|---|---|---|---|
| | (Meth)acrylic ester polymer (A) | | | | | | | | | | Silane |
| | | | | | Weight- | Plasticizer (B) | | | | | coupling |
| | | | | | average | | | | Molecular | Crosslinker | agent |
| | 2EHA | BA | 4HBA | AA | molecular | ATBC | Ac β CD | Ac γ CD | weight | (C) | (D) |
| Example 3-1 | 98 | — | 1.5 | 0.5 | 1.2 mil. | — | — | 10 | 2305 | 0.75 | 0.25 |
| Example 3-2 | 98 | — | 1.5 | 0.5 | 1.2 mil. | — | 10 | — | 2016 | 0.75 | 0.25 |
| Example 3-3 | 48 | 50 | 1 | 1 | 0.9 mil. | — | — | 10 | 2305 | 0.50 | — |
| Example 3-4 | 48 | 50 | 1 | 1 | 0.9 mil. | — | — | 2.5 | 2305 | 0.50 | — |
| Example 3-5 | 98 | — | 1.5 | 0.5 | 1.2 mil. | — | — | 2.5 | 2305 | 0.75 | 0.25 |
| Comparative | 98 | — | 1.5 | 0.5 | 1.2 mil. | — | — | — | — | 0.75 | 0.25 |
| Example 3-1 | | | | | | | | | | | |
| Comparative | 98 | — | 1.5 | 0.5 | 1.2 mil. | 10 | — | — | 412 | 0.75 | 0.25 |
| Example 3-2 | | | | | | | | | | | |

TABLE 6

| | Gel | Adhesive | Storage elastic | | | | | Breaking |
|---|---|---|---|---|---|---|---|---|
| | fraction | strength | modulus G′ (MPa) | | Modulus (N/mm²) | | | stress |
| | (%) | (N/25 mm) | −20° C. | 23° C. | 100% | 500% | 1000% | (N/mm²) |
| Example 3-1 | 66 | 4.7 | 0.12 | 0.05 | 0.013 | 0.033 | 0.246 | 0.390 |
| Example 3-2 | 73 | 3.9 | 0.13 | 0.05 | 0.020 | 0.063 | 0.477 | 0.502 |
| Example 3-3 | 82 | 2.9 | 0.10 | 0.05 | 0.044 | 0.118 | Broke | 0.360 |
| Example 3-4 | 87 | 2.2 | 0.09 | 0.04 | 0.040 | 0.201 | Broke | 0.664 |
| Example 3-5 | 86 | 2.6 | 0.12 | 0.04 | 0.016 | 0.063 | Broke | 0.238 |
| Comparative | 90 | 1.9 | 0.09 | 0.04 | 0.049 | 0.177 | Broke | 0.190 |
| Example 3-1 | | | | | | | | |
| Comparative | 82 | 0.4 | 0.09 | 0.04 | 0.021 | Broke | Broke | 0.118 |
| Example 3-2 | | | | | | | | |

| | | | | Total | | | |
|---|---|---|---|---|---|---|---|
| | | Haze value (%) | | luminous | | | |
| | Breaking | | After | trans- | Evaluation | | |
| | elongation | | 72 H at | mittance | of durability | | |
| | (%) | Normal | −20° C. | (%) | −30° C. | 23° C. | 80° C. |
| Example 3-1 | 1406 | 3.2 | 3.1 | 91.9 | A | A | B |
| Example 3-2 | 1074 | 5.6 | 5.4 | 91.9 | B | B | B |
| Example 3-3 | 857 | 3.0 | 2.9 | 91.2 | A | A | B |
| Example 3-4 | 893 | 3.1 | 2.9 | 91.8 | A | A | A |
| Example 3-5 | 886 | 1.1 | 1.3 | 91.9 | B | B | A |
| Comparative | 615 | 2.9 | 3.0 | 91.3 | C | C | B |
| Example 3-1 | | | | | | | |
| Comparative | 482 | 1.8 | 2.0 | 91.3 | B | C | C |
| Example 3-2 | | | | | | | |

As found from Table 6, the pressure sensitive adhesive sheets produced in Examples were excellent in the durability under any environment of low temperature (−30° C.), ordinary temperature (23° C.), and high temperature (80° C.) as compared to the pressure sensitive adhesive sheets produced in Comparative Examples. Moreover, the pressure sensitive adhesive sheets produced in Examples exhibited good optical properties (haze value and total luminous transmittance).

### INDUSTRIAL APPLICABILITY

The pressure sensitive adhesive sheet according to the first embodiment of the present invention is suitably used, for example, for bonding between a polarization plate and a retardation plate in a display body or between a retardation plate and another retardation plate.

The pressure sensitive adhesive sheets according to the second and third embodiments of the present invention are suitable for bonding between a bendable member and another bendable member that constitute a repetitive bending device.

### DESCRIPTION OF REFERENCE NUMERALS

1 Pressure sensitive adhesive sheet
11 Pressure sensitive adhesive layer
12a, 12b Release sheet
2 Optical film with pressure sensitive adhesive layer
21 Optical film
3 Optical laminate
21 First optical film
31 Second optical film
4 Repetitive bending laminate member
41 First bendable member
42 Second bendable member
5 Repetitive bending device
51 Cover film
52 First pressure sensitive adhesive layer
53 Polarization film
54 Second pressure sensitive adhesive layer
55 Touch sensor film
56 Third pressure sensitive adhesive layer
57 Organic EL element
58 Fourth pressure sensitive adhesive layer
59 TFT substrate
S Test piece
P Holding plate

1. A pressure sensitive adhesive used in optical applications,
the pressure sensitive adhesive containing a modified cyclodextrin having a degree of modification of more than 2.5 and 3.0 or less,
the pressure sensitive adhesive having a gel fraction of 1.0% or more.

2. The pressure sensitive adhesive according to claim 1, wherein the modified cyclodextrin is at least one of a modified β-cyclodextrin and a modified γ-cyclodextrin.

3. The pressure sensitive adhesive according to claim 1, wherein the modified cyclodextrin is a cyclodextrin modified with an acyl group.

4. The pressure sensitive adhesive according to claim 1, wherein the pressure sensitive adhesive contains a crosslinked product obtained by crosslinking a (meth)acrylic ester polymer with a crosslinker.

5. A pressure sensitive adhesive sheet having a pressure sensitive adhesive layer, the pressure sensitive adhesive layer being composed of the pressure sensitive adhesive according to claim 1.

6. The pressure sensitive adhesive sheet according to claim 5, having a 1000% modulus of 0.15 N/mm² or more and 1.00 N/mm² or less when a tensile test is performed at 23° C.

7. The pressure sensitive adhesive sheet according to claim 5, having an adhesive strength to soda-lime glass at 23° C. of 1 N/25 mm or more and 60 N/25 mm or less.

8. An optical film with pressure sensitive adhesive layer, comprising:
an optical film; and
a pressure sensitive adhesive layer laminated on at least one surface of the optical film, the pressure sensitive adhesive layer being that of the pressure sensitive adhesive sheet according to claim 5.

9. An optical laminate comprising:
a first optical film;
a second optical film; and
a pressure sensitive adhesive layer that bonds the first optical film and the second optical film to each other,
the pressure sensitive adhesive layer being that of the pressure sensitive adhesive sheet according to claim 5.
